(19) United States
(12) Patent Application Publication
(10) Pub. No.: US 2003/0097361 A1
(43) Pub. Date: May 22, 2003

(54) MESSAGE CENTER BASED DESKTOP SYSTEMS

(75) Inventors: ERWIN S. HUANG, SAN FRANCISCO, CA (US); CHAN F. CHUN, HONG KONG SAR (CN); CHAN S. KWAN, HONG KONG SAR (CN); TSE P. HUNG, HONG KONG SAR (CN); LAU C. KWOK, HONG KONG SAR (CN); WONG K. FUNG, HONG KONG SAR (CN); TSOI NG, HONG KONG SAR (CN); CHOW W. KIN, HONG KONG SAR (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DINH TRUONG T

(21) Appl. No.: 09/333,836

(22) Filed: Jun. 15, 1999

Related U.S. Application Data
(63) Continuation-in-part of application No. 09/239,412, filed on Jan. 28, 1999.
(60) Provisional application No. 60/111,341, filed on Dec. 7, 1998.

(51) Int. Cl. G06F 17/30

(52) U.S. Cl. 707/10

(57) ABSTRACT

A message center based desktop organizational and management system that includes a set of applications centered around and integrated with a message center. The applications cooperate to allow for creation, editing, manipulation, and maintenance of: (1) files and folders, (2) calendars, (3) to-do lists, (4) address books, (5) bookmarks, (6) data transfers, and others. In one method for processing data in a computer desktop, a message is received in the desktop and displayed when requested. A selection of data included in the displayed message is then received along with a command to process the selected data in a particular manner. The selected data is extracted and stored in a database. In response to certain types of command, a reminder message can be generated and sent. The selected data can relate to a calendar event, a to-do item, an address, a bookmark, a file, or others. The reminder message can be sent at one or more designated times, and to one or more designated recipients. The message can be displayed in a window that includes a set of buttons corresponding to available commands. An item stored in the database can be received and included in a message to be transmitted.

This application claims the benefit of U.S. provisional Application Serial No. 60/111,341, entitled “Virtual Desktop in a Computer Network,” filed Dec. 7, 1998, which is incorporated herein by reference. This application is also a continuation-in-part of U.S. application Ser. No. 09/239,412, entitled “Virtual Desktop in a Computer Network,” filed Jan. 28, 1999.

### BACKGROUND OF THE INVENTION

The present invention relates generally to techniques for processing data, and more particularly to desktop organizational and management systems based on a message center such as an electronics-mail (e-mail) application.

Many individuals extensively or periodically use a computer system for work or leisure. The computer system facilitates creation and maintenance of one or more databases of useful or potentially useful items such as e-mail messages, addresses, calendar events, to-do items, files, folders, and others. These items assist in organizing and managing the user's activities. Typically, one database is created for each category of information, and the databases are created based on the user's needs and preferences.

The contents of the databases are continually updated as new items are received or old items are discarded. Manipulation and management of some of the databases are achieved using tools provided by the computer's operating system. For example, a file management system provided by the operating system allows the user to create and maintain files and folders. Other databases are created and maintained by the user through the use of general or specialty applications. For example, a spread sheet application can be used to maintain a database of address information and a calendar application can be used to maintain the user's schedule.

Typically, maintenance of a particular database is achieved by manually manipulating the items in the database. For example, items in an address book are typically entered by typing the information in the address book database. To send address information to another user, the information can be retype or cut from the address book and paste onto a message or a file to be sent.

Items in the databases can also be sent and received via an e-mail application. E-mail applications are readily available to most users and are commonly used to send and receive texts and files. Typical e-mail applications allow the user to compose a new e-mail message by entering data in the various fields, such as the “TO”, “SUBJECT”, main body, and other fields. An address book may be provided that lists previously created addresses that can be used as recipients of the message. Tools may also be provided to allow for attachment of files or URL links to web sites. Generally, items in a received e-mail message (i.e., except for attachment files) are not easily extracted or manipulated (i.e., for storage to one of the databases described above).

Because separate and different applications are often used to collect and maintain data in various databases, the data is not easily shared between databases. The user may need to consult multiple databases via separate mechanisms to access the desired information. Moreover, because the e-mail application is basically designed to facilitate reception and transmission of texts and files, it is often cumbersome to extract items in received e-mail messages and save them into these databases, to retrieve items from the databases and integrate them into the e-mail messages.

As can be seen from the above, a desktop organization and management systems that effectively assist the user in receiving, manipulating, disseminating, and maintaining information are highly desirable.

### SUMMARY OF THE INVENTION

The invention provides a message center based desktop organizational and management system. The desktop system includes a set of applications centered around and integrated with a message center. In a specific embodiment, the message center is implemented using an electronics-mail (e-mail) application. In an embodiment, the set of applications includes applications that facilitate creation, editing, manipulation, and maintenance of: (1) files and folders, (2) calendars, (3) to-do lists, (4) address books, (5) bookmarks, (6) data transfers, and others. These applications cooperate to create a seamless work experience.

An embodiment of the invention provides a method for processing data in a computer desktop. In accordance with the method, a message is received in the desktop and displayed when requested. A selection of data included in the displayed message is then received along with a command to process the selected data in a particular manner. The selected data is extracted and stored in a database. In response to certain types of command, a reminder message is generated and sent. The selected data can relate to a calendar event, a to-do item, an address, a bookmark, a file, or others. The reminder message can be sent at one or more designated times, and to one or more designated recipients. The received message can be displayed in a window that includes a set of buttons for available commands. In a complementary manner, selection for an item stored in the database can be received and included in a message to be transmitted.

Another embodiment of the invention provides a computer-implemented method for processing data in a desktop. In accordance with the method, a messaging application that allows a user to send and receive messages is provided. The messaging application further allows the user to select and extract data included in a received message. A second application is also provided that receives the extracted data and, in response to some types of received data, directs generation of a reminder message. Additional applications can also be provided for enhanced functionality. For example, a third application can be provided that allows the user to manipulate files and folders. The third application can also save a file that has been extracted from a received message. A fourth application can be provided that receives an extracted URL link and saves the link in a bookmark database. A fifth application can be provided that receives an address and saves the address in an address book database.

Yet another embodiment of the invention provides a computer network configured to process data in a computing environment. The network includes one or more servers. At least one server includes a processor, an electronic storage medium, and a memory. The server is configured to send and receive messages, display a received message, receive a data item included in the displayed message, receive a command to process the selected data in a particular manner, extract the selected data, and store the data item in a database. The server is also configured to send a reminder message in response to certain types of command.

The invention further provides for computer program products that implements the methods described above.

The foregoing, together with other aspects of this invention, will become more apparent when referring to the following specification, claims, and accompanying drawings.

### BRIEF DESCRIPTION OF THE DRAWINGS

FIG. 1A shows a diagram of an embodiment of the message center based desktop organizational and management system of the invention;

FIG. 1B shows a diagram of an embodiment of the data flow in the message center based desktop system of the invention;

FIG. 2A shows a specific embodiment of a desktop that incorporates the message center based desktop system of the invention;

FIGS. 2B-2F show specific embodiments of the desktops for the calendar, to-do list, address book, bookmark, and file management applications, respectively;

FIGS. 3A and 3B show the process to send a reminder e-mail message from the calendar and to update the user's calendar with data from a received e-mail message, respectively;

FIGS. 4A and 4B show the process to send a reminder e-mail message from the to-do list and to update of the user's to-do list with data from a received e-mail message, respectively;

FIGS. 5A and 5B show the process to send addresses in an e-mail message and to update of the user's address book with information in a received e-mail message, respectively;

FIGS. 6A and 6B show the process to update the user's bookmark database with links included in a received e-mail message and to send a bookmark from the bookmark database, respectively;

FIGS. 7A and 7B show the process to send one or more files as an attachment in an e-mail message and to extract and store to the user's filing system a file received as an attachment in an e-mail message, respectively;

FIG. 8 shows a simplified flow diagram that describes the data extraction process for a received message;

FIG. 9 is a diagram that illustrates the enormous interconnectivity provided by an Internet-based computer network of the invention;

FIG. 10 shows a diagram of an embodiment of a computer network that implements a virtual computing environment and supports the virtual desktop of the invention;

FIG. 11 shows a diagram of a browser display of a representative virtual desktop for a particular user that has been retrieved from the URL web site;

FIG. 12 shows, in summary form, some of the processes and features provided by the virtual desktop of the invention;

FIG. 13 shows a diagram of an embodiment of the data stored for the users in the virtual computing environment;

FIG. 14 shows a diagram of some of the processes of the file management system of the invention;

FIG. 15 shows a diagram of additional processes of the file management system of the invention;

FIG. 16 shows a simplified diagram of an embodiment of the file synchronization feature of the invention;

FIG. 17 shows a diagram of an embodiment of the bookmark synchronization feature of the invention;

FIG. 18 shows a diagram of an embodiment of some of the features provided by a personal information manager of the invention;

FIG. 19 shows a simplified diagram of an embodiment of the customization process for the virtual desktop of the invention;

FIG. 20 shows a diagram of an embodiment of the security provided for the virtual desktop of the invention;

FIGS. 21A and 21B show a flow diagram that describes an implementation of an embodiment of the virtual desktop of the invention;

FIG. 22 shows a flow diagram that describes an implementation of an embodiment of the file synchronization of the invention; and

FIG. 23 shows the basic subsystems of a server suitable for use with the invention.

### DESCRIPTION OF THE SPECIFIC EMBODIMENTS

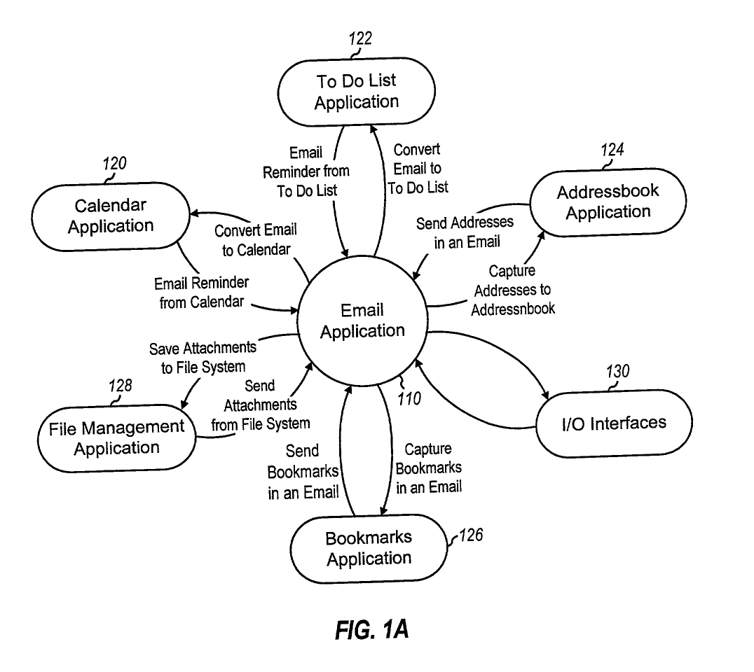

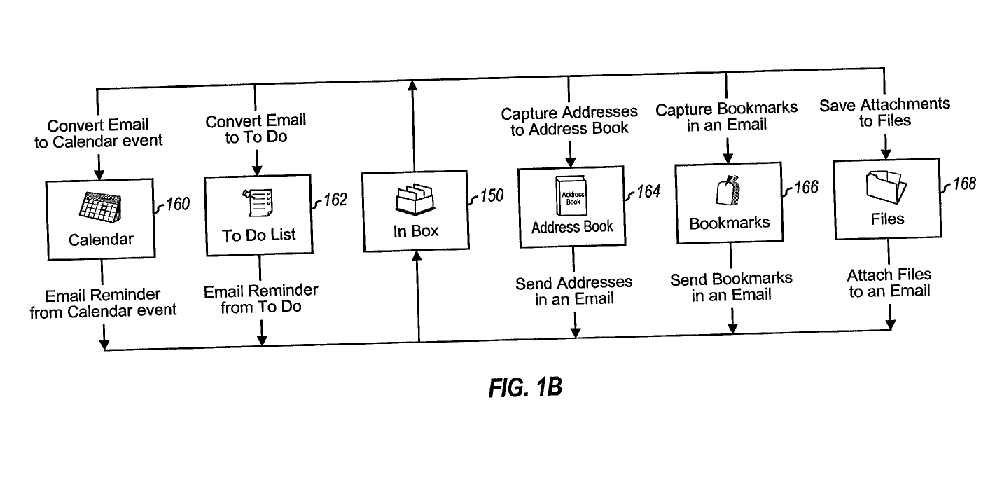

FIG. 1A shows a diagram of an embodiment of the message center based desktop organizational and management system of the invention. A message center 110 is the central application that interacts with other applications to provide the user with the necessary desktop organizational and management tools. In the specific embodiment shown in FIG. 1A, six other applications interact with message center 110 including a calendar application 120, a to-do application 122, an address book application 124, a bookmark application 126, a file management application 128, and an I/O interface application 130. message center 110 can be designed to interact with other applications to provide additional functionality and this is within the scope of the invention. Also, the invention can operate with a subset of the applications shown in FIG. 1A.

Integration of the applications shown in FIG. 1A provides a desktop organizational and management system that provides many advantages. Each application is adapted to manipulate a particular category or data (e.g., addresses, bookmarks, files, and so on). The items in each category can be accessed and manipulated by the user via the appropriate application. In addition, through the message center, the user is easily and quickly able to categorize, store, retrieve, and use items stored in the databases or received e-mail messages to effectively organize and manage the user's activities. These advantages are described in further detail below.

Message center 110 can be implemented with an e-mail application or other data messaging applications. Generally, message center 110 receives information from a source (i.e., in the form or a message) and allows the user to extract and store items in the received message. Message center 110 also allows the user to generate and send new messages that incorporate information from the available databases. For simplicity, the invention is described in the context of a message center implemented with an e-mail application that receives and sends e-mail messages. However, other messaging applications can be used and are within the scope of the invention.

In FIG. 1A, the user can initially receive an e-mail message. Based on the data in the received e-mail message, the user can convert the message to a calendar event or a to-do item. The addresses and any bookmarks in the e-mail message can also be captured and stored in the appropriate databases. Any files or folders sent as an attachment in the message can also be extracted and stored. For e-mail messages that have been converted to calendar events or to-do items, and for calendar events or to-do items captured by other mechanisms, reminder e-mail messages can be sent to remind the interested parties. Addresses, bookmarks, and files can also be retrieved from the appropriated databases and included in outgoing e-mail messages. Thus, through a set of highly integrated applications, data can be easily extracted, manipulated, and used to organize and manage the user's work and personal environment.

Although FIG. 1A depicts seven separate and independent applications, in practice, these applications can be integrated into one or more applications having modules that interface to perform the required functionality. The modules can reside on one or more computer systems. Various implementations of the invention can be contemplated and are within the scope of the invention.

Data associated with the various applications can be stored on the local PC computer or a file server, or both, and can be stored in one or more databases. For example, data for the calendar of events, list of to-do items, address book, bookmarks, and files and folders can be includes in a single database. A field can be associated with each data item to indicate the application to which the data pertains. Alternatively, the data can be partitioned and stored in separate databases on one or more file servers.

FIG. 1B shows a diagram of an embodiment of the data flow in the message center based desktop system of the invention. In the specific embodiment shown in FIG. 1B, six databases are provided that include an e-mail database 150, a calendar database 152, a to-do database 154, an address database 156, a bookmark database 158, and a file database 160. These databases can also be integrated into one or more larger databases, with each item in the database properly designated to indicate its type.

E-mail database 150 interacts with the other databases such that items in a received e-mail message can be selected, extracted and stored in these databases. Items in calendar database 152 and to-do database 154 can invoke reminder e-mail messages to be sent, which are then received in the recipient's e-mail in box. Items in address database 156 and bookmark database 158 can be included in outgoing e-mail messages. Similarly, files and folders in file database 160 can be attached in outgoing e-mail messages.

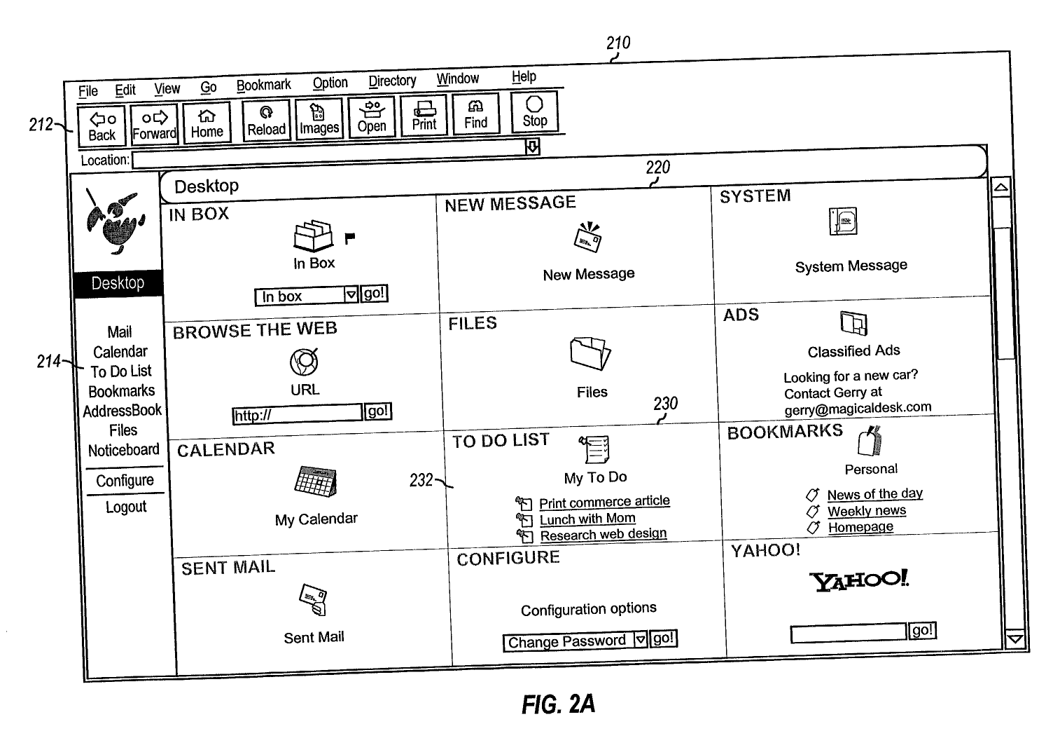

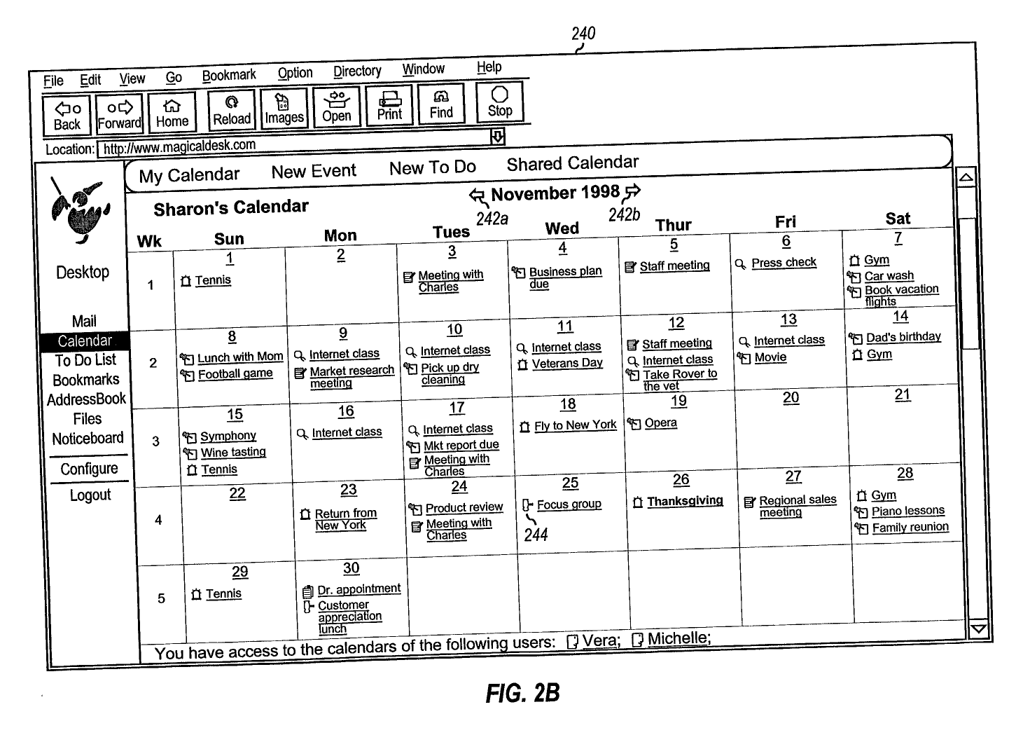

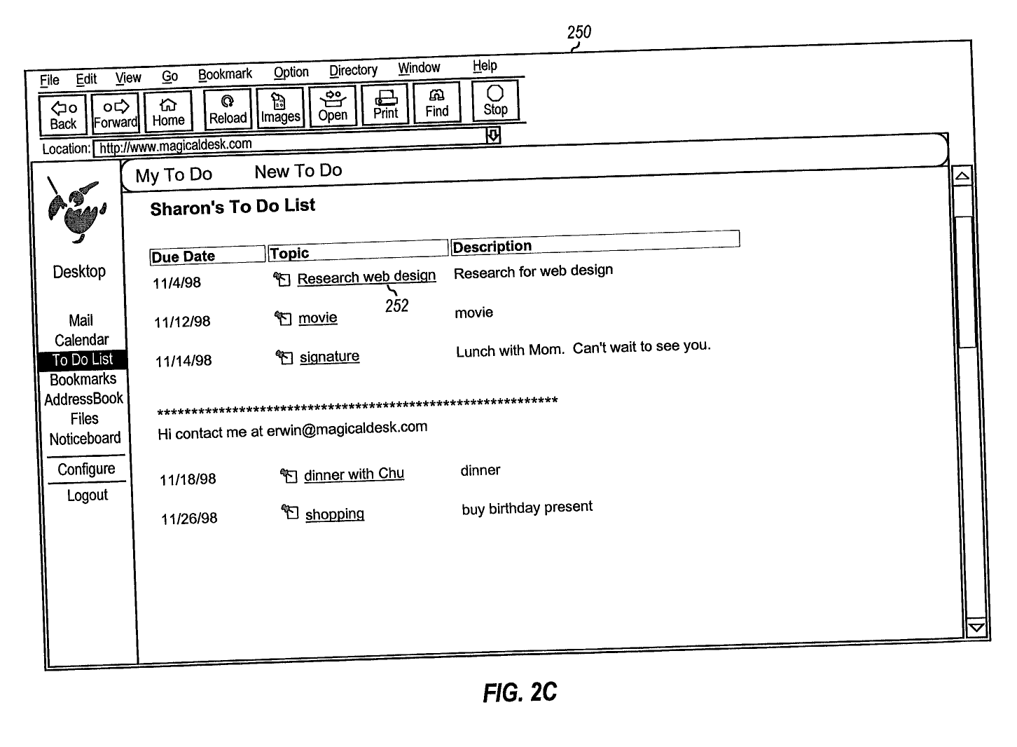

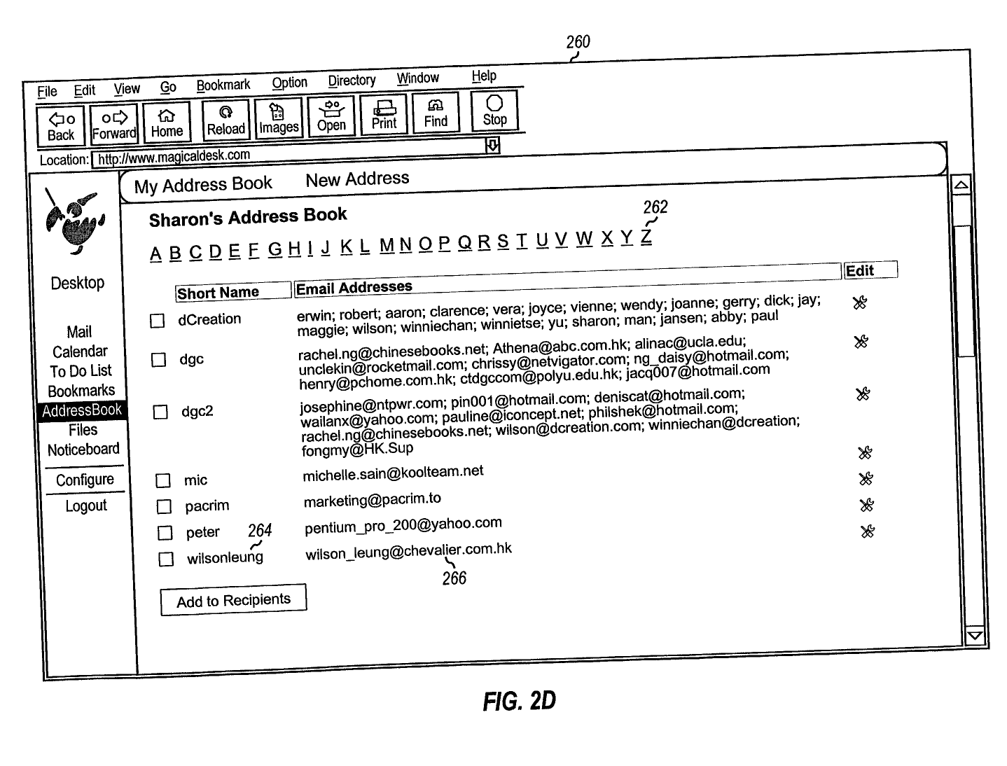

FIG. 2A shows a specific embodiment of a desktop 210 that incorporates the message center based desktop system of the invention. In a specific embodiment, desktop 210 is implemented as a virtual desktop using a web browser, as described the aforementioned U.S. Pat. No. 09/239,412. In the detailed description to follow, the invention is described in the context of a virtual desktop. However, the invention can also be practice in conventional computer desktops.

In the specific embodiment shown in FIG. 2A, desktop 210 includes a system tool bar 212, a menu control area 214, and a work area 220. One of the buttons on tool bar 212 allows the user to jump between (virtual) desktop 210 and a local PC desktop. Tool bar 212 also provides other browser functions. In an embodiment, control area 214 lists, among other items, the organizational and management applications available to the user. Control area 214 is conveniently located in a section of desktop 210 for easy user access to the applications. In an embodiment, items in the menu of the available applications in control area 214 are highlighted as the user navigates through various applications in the desktop.

Work area 220 can be arranged in various manners depending on, for example, the user's needs and preferences. In a specific implementation, work area 220 is partitioned into a number of sections 230. Each section is associated with a topic. For example, one section can be designated for each of the applications shown in control area 214. The sections are labeled for easy identification by the user. Each section also includes a section area 232 that can include icons, a listing, a query box, and other objects to be associated with that section, or a combination of the above. The user, through a customization application described below, is able to select and arrange the items in each section area, and to configure the section area to display the desired information in the desired format.

FIGS. 2B-2F show specific embodiments of the desktops for the calendar, to-do list, address book, bookmark, and file management applications, respectively. Each of these desktops can be reached by selecting the appropriate application shown in control area 214.

The interaction of the various applications with the message center (or e-mail application) is further described below.

Message Center

Referring back to FIG. 1A, message center 110 is the centerpiece that interfaces with other applications and assists in the manipulation and transfer of data between the various applications. Message center 110 can be implemented as a custom application with codes written to perform the functions described herein. Message center 110 can also be implemented with an e-mail application. Typical e-mail applications include facilities to send and receive data and files. Modifications can be made to conventional e-mail applications to allow for extraction of data and files from e-mail messages, and for incorporation of the extracted information into other databases (e.g., bookmark, calendar, and so on) maintained by other applications. In this manner, data can be easily sorted and stored to the appropriate databases and retrieved for use at a later time. The various functionality and capabilities of the message center are described in detail below in conjunction with the message center's interactions with other applications.

Calendar Application

Referring back to FIG. 1A, calendar application 120 cooperates with message center 110 to assist the user in maintaining the user's schedule. Information on the user calendar can be shared with, or provided to message center 110. Further, the calendar can be updated with information received from message center 110.

FIG. 2B shows a specific embodiment of a desktop 240 that displays a user's calendar in the desktop work area. Similar to some conventional calendar, desktop 240 display one month of events. However, desktop 240 can be configured to display two or more months of events (i.e., by reducing the size of the calendar for each month), or less than one month's worth of events. The user is able to view a previous month or a future month by advancing on arrows 242a and 242b, respectively.

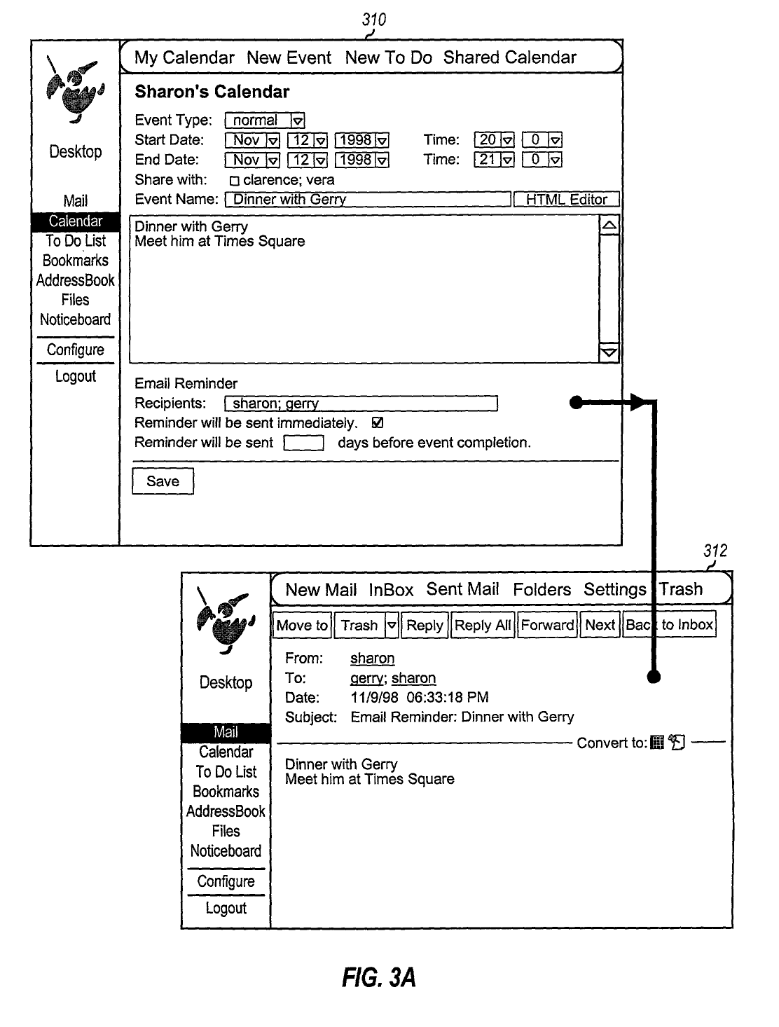

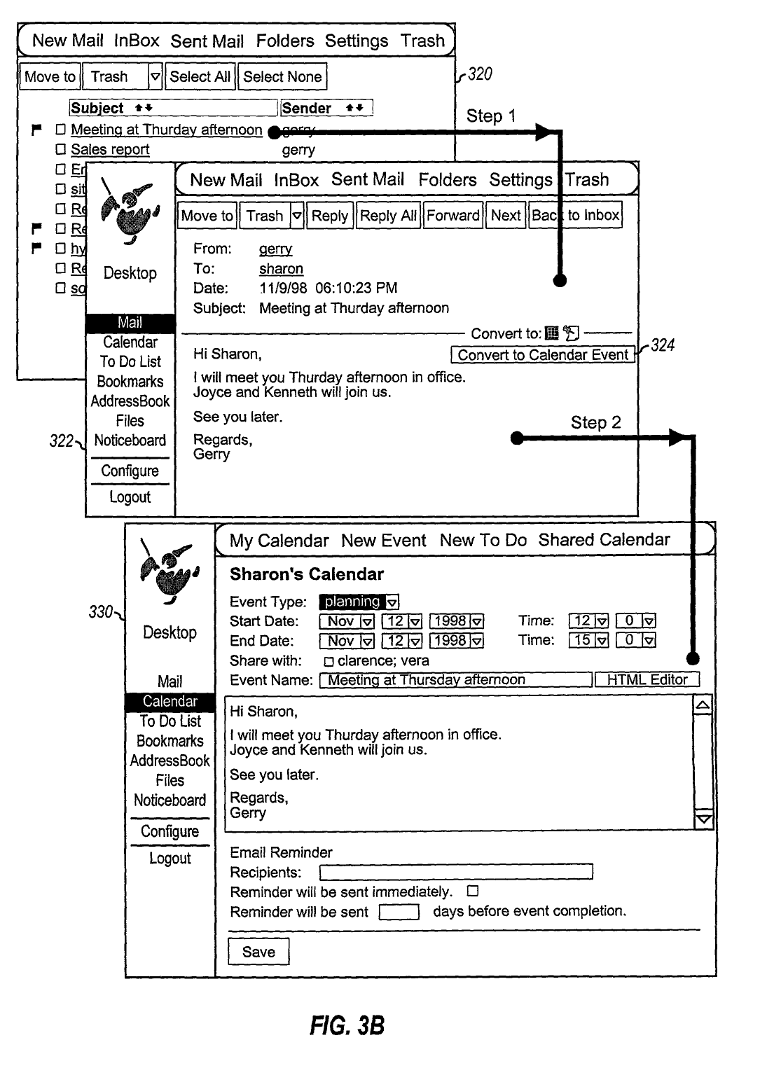

For each day in the calendar, a list 244 of icons appears that summarizes the events for that particular day. The user can view the details of a particular event by clicking on the icon for the event. In response, an event window 310 appears (see FIG. 3A) that displays information for the selected event.

FIG. 3A shows the interaction between the calendar application and the e-mail application to send a reminder e-mail message from the calendar. As events in the user's calendar arrive, the calendar application can direct e-mail application to send e-mail messages to remind the interested parties (e.g., the participants, secretaries, and others) of the upcoming events. The reminder e-mail message is displayed in an e-mail window 312, and can include information related to the selected event, as shown in event window 310. The reminder e-mail message can be sent on the day of an event, or one or more designated times before the date of the event, or both. The reminder e-mail message can be sent to the interested parties automatically. Alternatively, the user can select to review the reminder e-mail message before it is sent. This reminder feature is particularly helpful in confirming meetings and appointments.

FIG. 3B shows the interaction between the calendar application and the e-mail application to update the user's calendar with data from a received e-mail message. The user initially receives new e-mail messages that are listed in the user's in-box screen 320. The user selects and views an e-mail message by clicking on the selected message, which opens an e-mail window 322. Window 322 display information in the selected e-mail message. Window 322 further conveniently includes an icon 324 that allows the user to convert the received e-mail into a calendar event. By clicking on icon 324, a calendar dialog window 330 appears that incorporates much of the information in the selected e-mail message. For example, the information in the e-mail message including the parties, a description of the event, the time and place of the event, and so on, can be extracted from the e-mail message and entered into the calendar. Because of the interaction between the e-mail application and the calendar application, the information from a received e-mail message can be extracted and posted to the user's calendar without undue effort to retype or otherwise re-enter the information.

In an embodiment, window 330 further includes fields that allow the user to: (1) categorize the event, (2) identify the date, (3) select whom and when to send reminder e-mail messages, (4) save the event, and perform other functions. The user can select to be reminded, for example, the day before the event.

To-Do Application

Message center 10 also cooperates with to-do application 122 to assist the user in planning, coordinating, and maintaining the user's list of to-do items. For example, as items become due, to-do application 122 can direct e-mail application to send e-mail messages reminding the user of the upcoming deadlines. The reminder e-mail messages can be sent on the day of the event, or one or more designated times before the date of the event, or both.

FIG. 2C shows a specific embodiment of a desktop 250 that displays the to-do list in the desktop work area. Desktop 250 displays short descriptions of the to-do items and their due dates. Desktop 250 can also include links 252 that the user can activate to retrieve additional information pertaining to a particular to-do item.

The combination of to-do application 122 and message center 120 can implement many functions. For example, this combination can be used to provide “docketing” functions for the user. This feature is especially useful for a user who has many new and/or recurring deadlines.

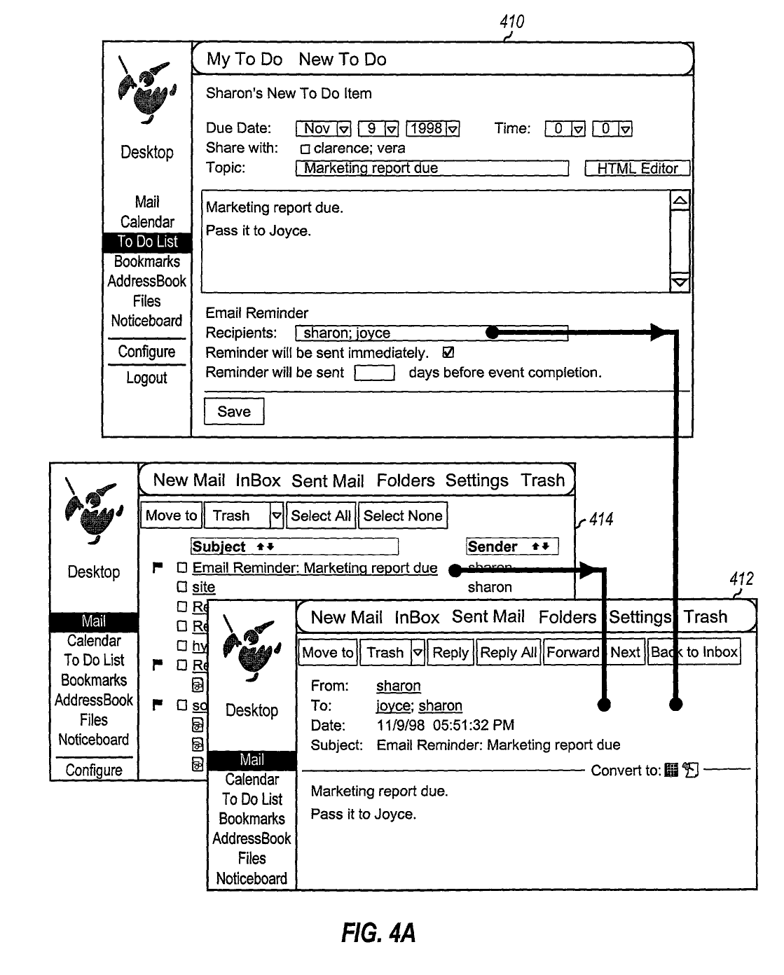

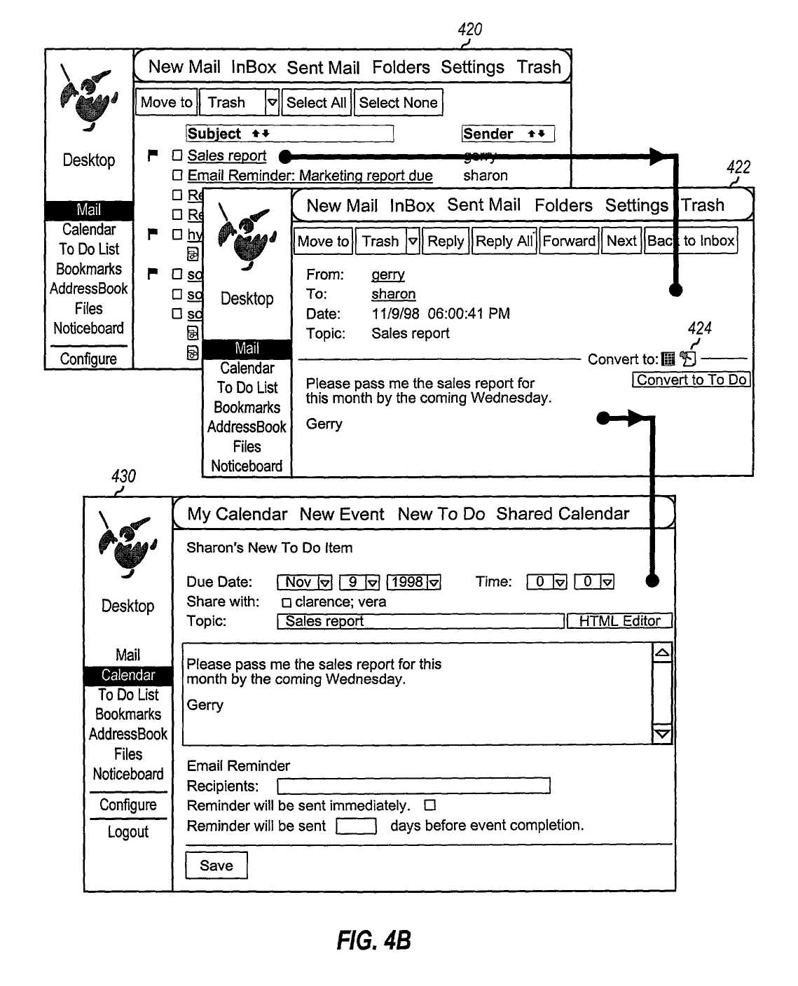

FIG. 4A shows the interaction between the to-do application and the e-mail application to send a reminder e-mail message from the to-do list. A to-do window 410 can be invoked (i.e., from the to-do list desktop) to display a particular to-do item. As items in the user's to-do list become due, the to-do application can direct the e-mail application to send an e-mail message reminding the interested parties of the upcoming deadlines. The reminder e-mail message is shown in an e-mail window 412, and can include information associated with the to-do item. This reminder e-mail message is sent to interested parties, and is received in a recipient's inbox window 414.

The reminder e-mail messages can be sent on the due date of the item, or one or more designated times before the due date, or both. For example, the user can select to have the to-do application direct the e-mail application to send reminder messages each morning for items having due dates on that day. The user can also select to have reminder messages sent prior to the due date, for example, a week from that day. When entering an item in the to-do list, the user can designate when the reminder message should be sent, if at all, as well as how often the reminder message is to be sent. This allows the user to receive an earlier reminder for items that may require a longer period of time to prepare and respond. After the due date, the expired item in the to-do list can be removed or discarded, or collected in an expired to-do database that can be used to provide record-keeping for the user.

FIG. 4B shows the interaction between the to-do application and the message center to update of the user's to-do list with data from a received e-mail message. The user can conveniently enter items in the to-do list using various methods, including through the e-mail application. The user selects a received e-mail message in an inbox window 420 for viewing. In response, an e-mail window 422 displays the selected message. Window 422 further conveniently includes an icon 424 that allows the user to convert the received e-mail message into a to-do item. By clicking on icon 424, a to-do dialog window 430 appears that incorporates much of the information in the selected e-mail message. For example, the information in the e-mail message, including a description of the to do item, the due date, and other information, can be extracted from the e-mail message and entered into the to-do list. Because of the cooperation between the e-mail application and the to-do application, the information in the received e-mail message can be extracted and posted to the user's to-do list, without undue effort to retype or otherwise re-enter the information.

In entering the item in the to-do list, the user can also categorize the items. For example, the user can choose to indicate whether the item is marginally important, important, extremely important, and so on. Thus, when receiving a reminder e-mail message or a report of the to-do items, the more important items can be indicated accordingly (e.g., with different colored text, bolded text, or other notations).

Address Book Application

Address book application 124 assist the user to maintain a database of address, contact, and other (i.e., personal) information. This database is generically referred to as the user's address book. The address book can contain, for example, home addresses, business addresses, e-mail addresses, dates (e.g., birthdays, anniversaries, and so on), and various other information that the user deemed important enough to save. The address book is stored in an address data file.

FIG. 2D shows a specific embodiment of a desktop 260 that displays the user's (e-mail) addresses in the desktop work area. Desktop 260 includes an alphabetical index 262 that can be used to catalog addresses. Desktop 260 also includes a field 264 for short names (or nicknames). Each short name identifies a particular address or group of addresses. Desktop 266 further includes a field 266 that lists the e-mail address(es) associated with each short name. The user can retrieve additional information for a particular name in desktop 260 by simply clicking on that name. The user can also create a group address that includes a set of members and their addresses. Subsequently, the user is able to send a message to all members of the group by simply indicating the short name of the group in the recipient field of the e-mail message.

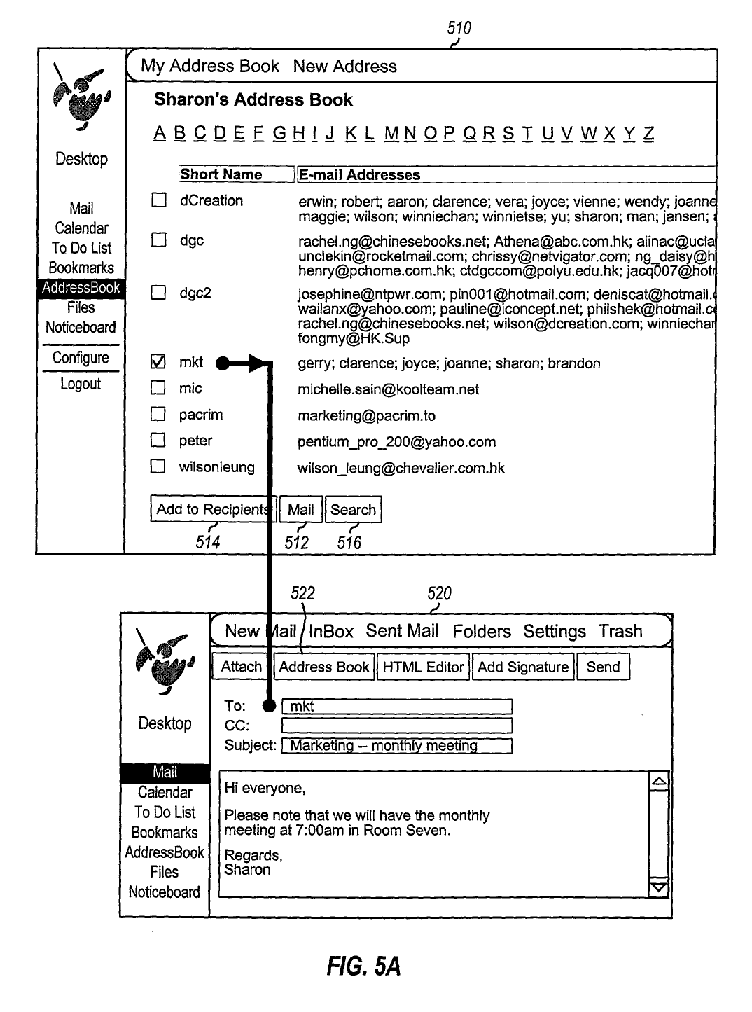

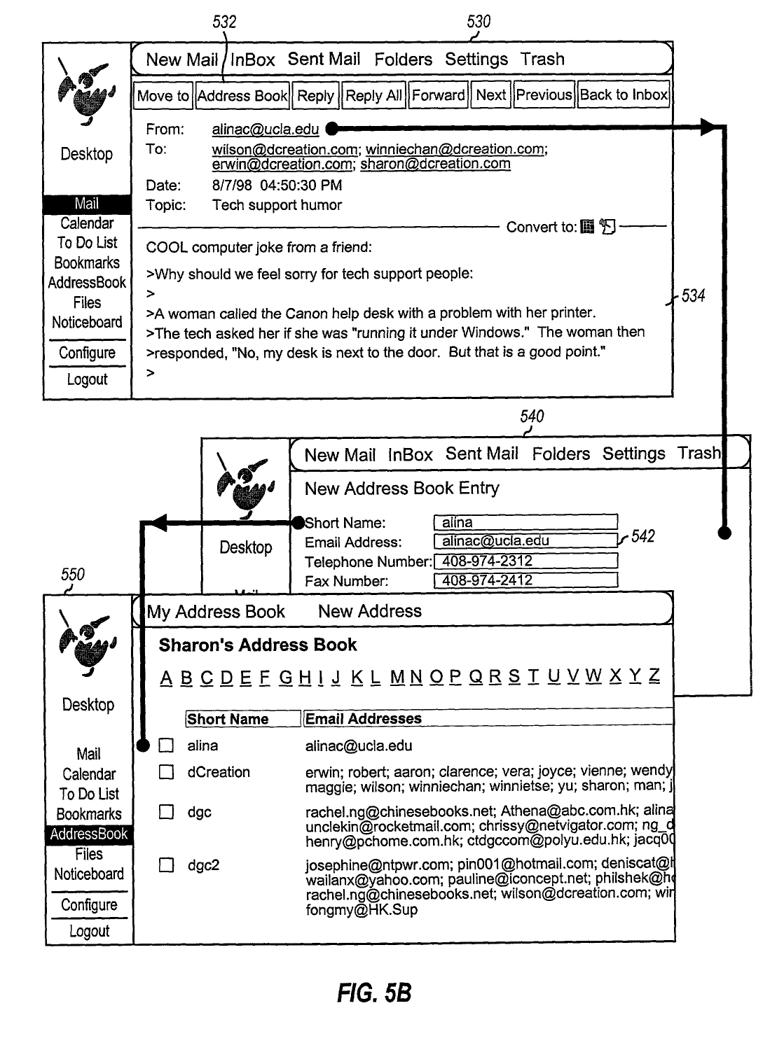

FIG. 5A shows the interaction between the address book application and the e-mail application to send addresses in an e-mail message. Within an address book window 510, a button 512 is provided to send an e-mail message. The user selects an address from the address book and clicks on mail button 512. An e-mail window 520 for a new message then appears. The mail message includes the address just selected in the “TO” field. The user then enters information in the other fields in the e-mail message and sends off the e-mail.

Alternatively, the user can open e-mail window 520 in a normal manner via the e-mail application. The address book can be consulted at any time and, in particular, when the user sends a new e-mail message. Within window 520, a button 522 is provided that, when activated, displays the address book. The user can consult the address book for addresses of recipients (e.g., the “TO” and “CC” recipients) of the message. The user can designate a particular recipient field in the e-mail window (i.e., by moving the cursor into the selected field), move over to address book window 510 and select one or more addresses, and click on button 514 to add the selected address(es) to the recipient field of the e-mail message.

A search tool can also be provided to allow the user to search for an address in the address book. The search for a particular expression can be activated by clicking on a search button 516. For example, the user can search for all occurrences of “John” in the address book. A listing of, for example, “John,” “Johns,” “Johnson,” and “Johnston” can be retrieved from the address book. The user can select the desired address(es), move over to a recipient field on the e-mail, and paste the selected address(es). Alternatively, the user can refine the search criterion and restart the search.

FIG. 5B shows the interaction between the address book application and the e-mail application to update of the user's address book with information in a received e-mail message. Because the address book application is integrated with the e-mail application, information in the received e-mail message can be conveniently extracted and entered into the address book. Initially, the user views an e-mail message in an e-mail window 530. The user then selects an address or a group of addresses in the e-mail message (i.e., addresses in the “FROM,” “TO,” “CC,” or main body field, or a combination of the above). The user then clicks on a button 532 that allows the user to add the selected address(es) to the address book. As a result of clicking on button 532, an address dialog window 540 appears that includes the selected e-mail address(es) in an e-mail address field 542. The user can then choose to enter additional information to be associated with the selected address or group of addresses, including the short name, contact telephone, and other information. The user can move back and forth between windows 530 and 540. Information in an e-mail body 534 or other parts of the e-mail message can be selected (i.e., highlighted using a mouse) and pasted onto the address book. The information in window 540 is updated to the address book, as shown by an address book window 550.

Bookmark Application

FIG. 2E shows a specific embodiment of a desktop 270 that displays the user's bookmarks (or URL links) 272 in the desktop work area. Bookmark application 126 allows the user to maintain a database of bookmarks to web sites. The bookmarks can be arranged in alphabetical order, in chronological order, by category (as shown in FIG. 2E), or by other arrangements. The web site pointed to by a URL link can be accessed by simply clicking on the bookmark.

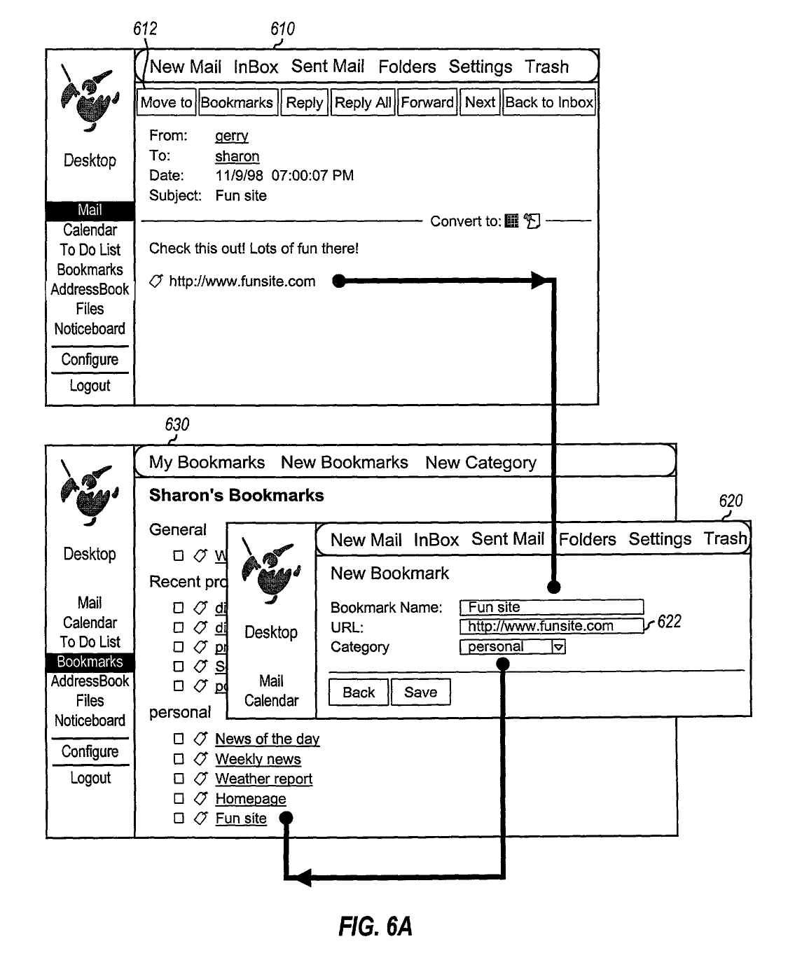

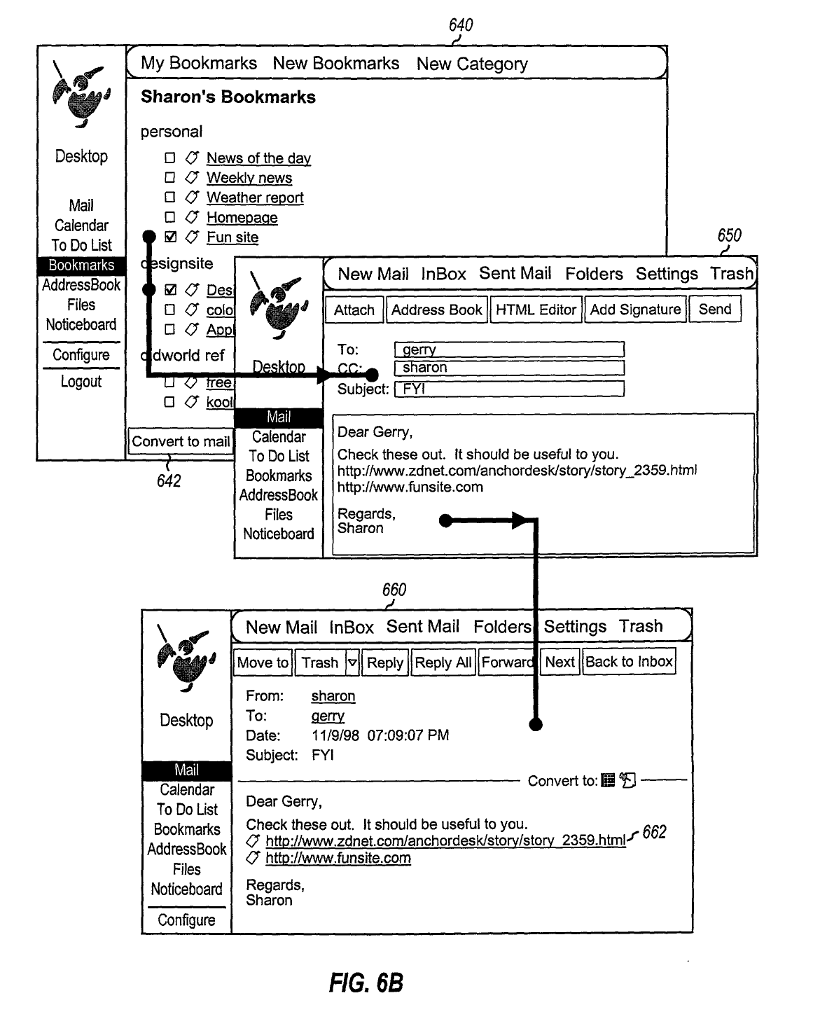

FIG. 6A shows the interaction between the bookmark application and the e-mail application to update the user's bookmark database with links included in a received e-mail message. Initially, the user views the e-mail message in an e-mail window 610. The user then selects a link included in the e-mail message (i.e., by clicking on it once). The user then clicks on a button 612 that allows the user to add the selected link to the bookmarks database. As a result of clicking on button 612, a dialog window 620 appears that includes the selected bookmark in a URL field 622 of the dialog window. The user can then choose to enter additional information to be associated with the selected link, such as the bookmark name and category. The information in window 620 is updated to the bookmark database, as shown by a bookmark window 630.

FIG. 6B shows the interaction between the bookmark application and the e-mail application to send a bookmark from the bookmark database. Within a bookmark window 640, a button 642 is provided to send an e-mail message. The user selects one or more bookmarks in window 640 and clicks on mail button 642. An e-mail window 650 then appears that includes the selected bookmarks in the main body of the e-mail message. The user can enter additional information in the various fields in the e-mail message and sends off the e-mail. The e-mail message is received and opened in an e-mail window 660. The e-mail message includes links 662 that can be accessed by clicking on the links.

File Management Application

File management application 128 allows the user to process, manipulate, and manage files. Integration of file management application 128 and message center 110 facilitates in the reception and transmission of the files.

FIG. 2F shows a specific embodiment of a desktop 280 that displays the user's files and folders in the desktop work area. File management application 128 allows the user to perform file manipulation functions such as create, copy, cut, paste, and others. Files and folders can also be uploaded to the (virtual) desktop from the local PC desktop, or downloaded from the (virtual) desktop to the local PC desktop. The file and folders can be arranged in alphabetical order, in chronological order (as shown in FIG. 2F), by category, or by other arrangements.

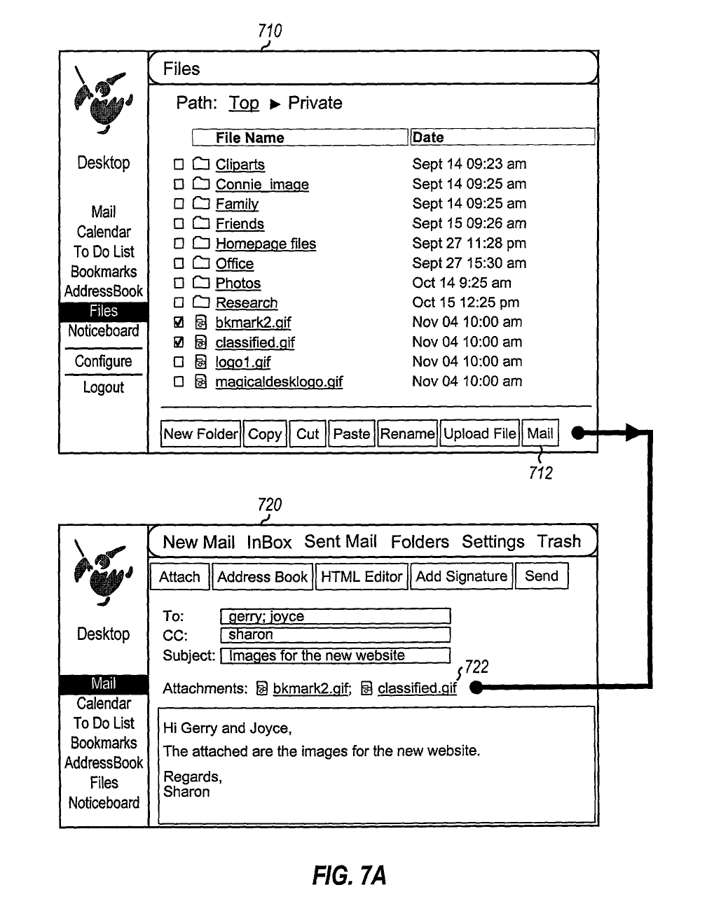

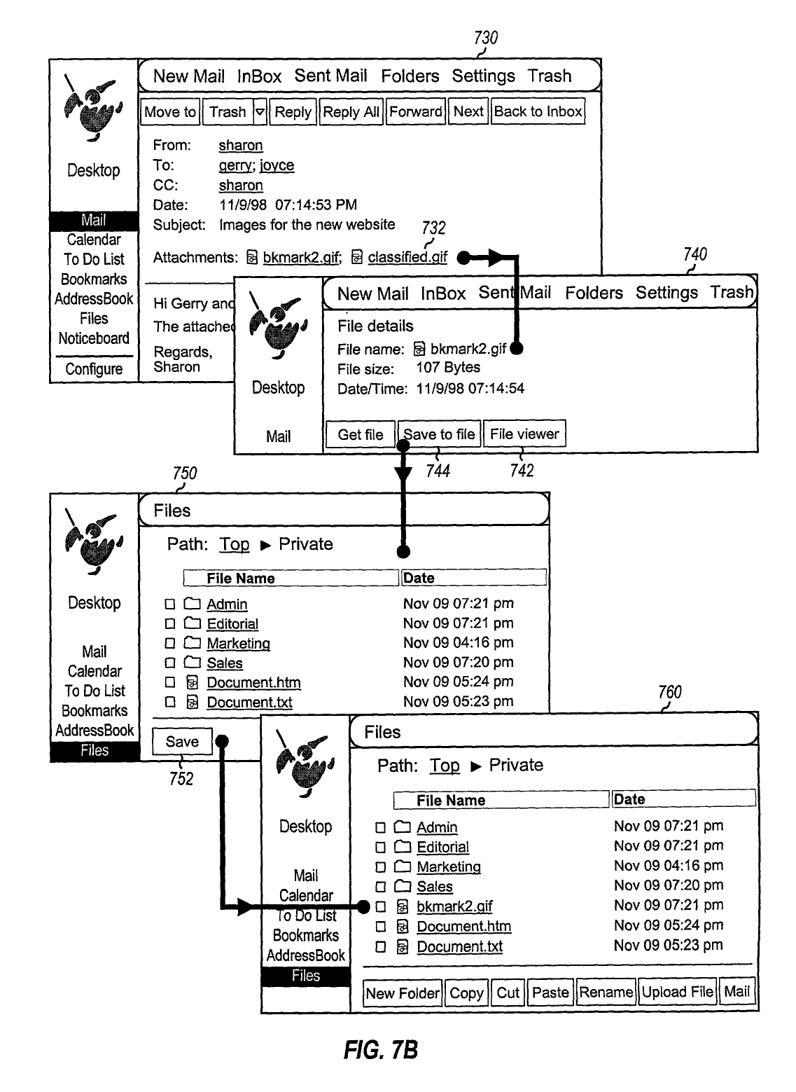

FIG. 7A shows the interaction between the file management application and the e-mail application to send one or more files as an attachment in an e-mail message. Within a file window 710, a button 712 is provided to compose an e-mail message. The user selects a set of files and folders from window 710 and clicks on mail button 712. An e-mail window 720 then appears which includes the selected set of files and folders in an attachment section 722 of the e-mail message. The user can enter additional information in other fields in the e-mail message and sends it.

FIG. 7B shows the interaction between the file management application and the e-mail application to extract and store to the user's filing system a file received as an attachment in an e-mail message. Initially, the user views the e-mail message in an e-mail window 730. The user then selects one or more attachment files 732 included in the e-mail message (i.e., by clicking on the file once). As a result of clicking on the file, a dialog window 740 appears that includes information on the selected file. The user can choose to view the contents of the selected file by clicking on a view button 742. Alternatively, the user can choose to save the selected file by clicking on a save button 744. A file window 750 then appears as the result of button 744 being activated. The user can then save the selected file by clicking on a save button 752. A file window 760 displays the selected file as one of the file in the file system. In another implementation, by clicking on button 744 in window 740, the selected file can be saved and displayed in window 760, as indicated by the dashed line, and window 750 can be omitted from display.

I/O Interface Application

I/O interface application 130 facilitates in the transmission and reception of messages by the message center. I/O interface application 130 can be coupled to, and direct the operation of a number of different I/O devices such as those that transmit facsimile, voice, video, data, and others, or a combination of the above.

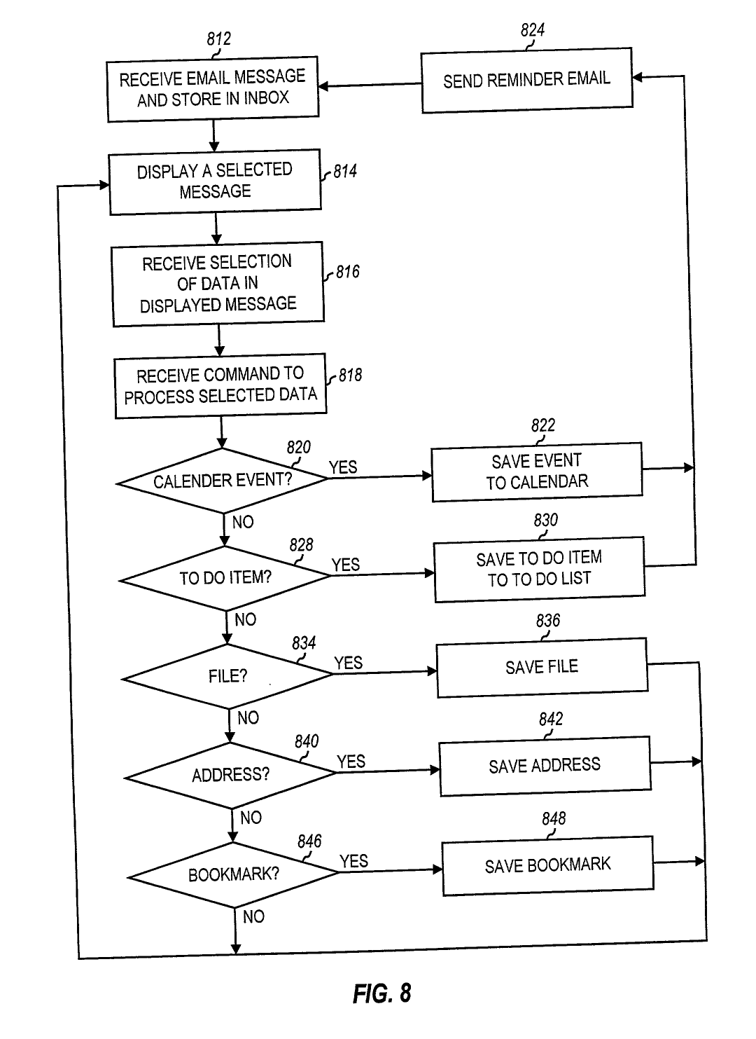

FIG. 8 shows a simplified flow diagram that describes the data extraction process for a received message. Initially, at step 812, an e-mail message is received and stored in the user's inbox. At a convenient point in time, the user selects a message from the inbox and the selected message is displayed, at step 814. The user views the message and can select data from the message for processing. The selected data is received at step 816 and the command indicative of the desired processing is received at step 818.

A decision is then made whether the command is for processing a calendar event, at step 820. If the answer is yes, the event is saved to the user's calendar, at step 822. A reminder e-mail message is later sent to the interested parties, at step 824, and the process returns to step 812. The reminder e-mail message is received in similar manner as other e-mail messages.

If the command is for not for processing a calendar event, a decision is then made whether the command is for processing a to-do item, at step 828. If the answer is yes, the to-do item is saved to the user's to-do list, at step 830. A reminder e-mail message is later sent to the interested parties, at step 824, and the process returns to step 812.

If the command is not for processing a to-do item, a decision is then made whether the command is for processing a file, at step 834. If the answer is yes, the file is saved to the user's file system, at step 836. The process then returns to step 814.

If the command is not for processing a file, a decision is then made whether the command is for processing an address, at step 840. If the answer is yes, the address is saved to the user's address book, at step 842. The process then returns to step 814.

If the command is not for processing an address, a decision is then made whether the command is for processing a bookmark, at step 846. If the answer is yes, the bookmark is saved to the user's bookmark database, at step 848. The process then returns to step 814.

The application can also be designed to process the received command in different orders than that shown in FIG. 8. Further, fewer or additional categories can be checked than that shown in FIG. 8.

As illustrated by the figures described above, a particularly advantageous aspect of the invention is the incorporation of buttons within the various windows that efficiently and effectively link together the applications. A particular set of buttons is provided for each typically of window. The buttons provided are based on the context in which the window is opened, and represent the choices available to the user. The buttons facilitate integration and transfer of data associated with one application (e.g., address book) to another application (e.g., e-mail).

The message center based desktop system of the invention can be implemented in various computer systems. One specific implementation of the invention in a virtual desktop environment is described below. In the virtual desktop implementation, the databases for the user can be maintained on the local desktop PC, the server, or both.

System Description

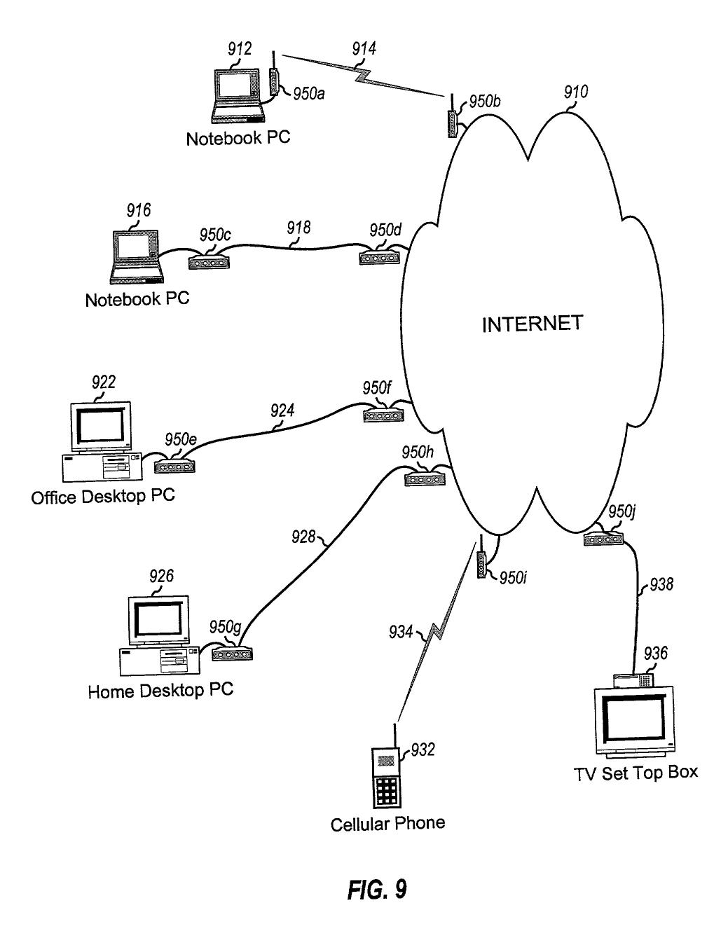

FIG. 9 is a diagram that illustrates the enormous interconnectivity provided by an Internet-based computer network of the invention. As shown in FIG. 9, numerous systems can gain access to the Internet 910 through a wide range of communications channels. For example, access to the Internet 910 can be gained by a portable notebook personal computer (PC) 912 though a wireless link 914, a notebook PC 916 through a wireline link 918, an office desktop PC 922 through a high speed modem link 924 (e.g., T1, ISDN, or others), a home desktop PC 926 through a telephone link 928, a mobile cellular phone 932 through a cellular link 934, and a television set top box 936 through a cable link 938. In FIG. 9, modems 950 facilitate communications between the respective systems and the Internet. Although all modems are similarly designated in FIG. 9, in actuality, they are specifically designed to support the particular link to which they are coupled. The connections are typically TCP/IP (Transmission Control Protocol/Internet Protocol) connections, but other connections and protocols are possible. For example, the connection may be a SLIP/PPP (Serial Link IP/Point-to-Point Protocol) connection.

Other communications links that may be used to connect to the Internet include, for example, a terrestrial link, a microwave link, a satellite link, and others. The communications link can be symmetric (i.e., having the same data bandwidth in both directions). Alternatively, the communications link can be unsymmetrical such that, for example, the downstream bandwidth from the Internet to the system is greater than the upstream bandwidth from the system to the Internet.

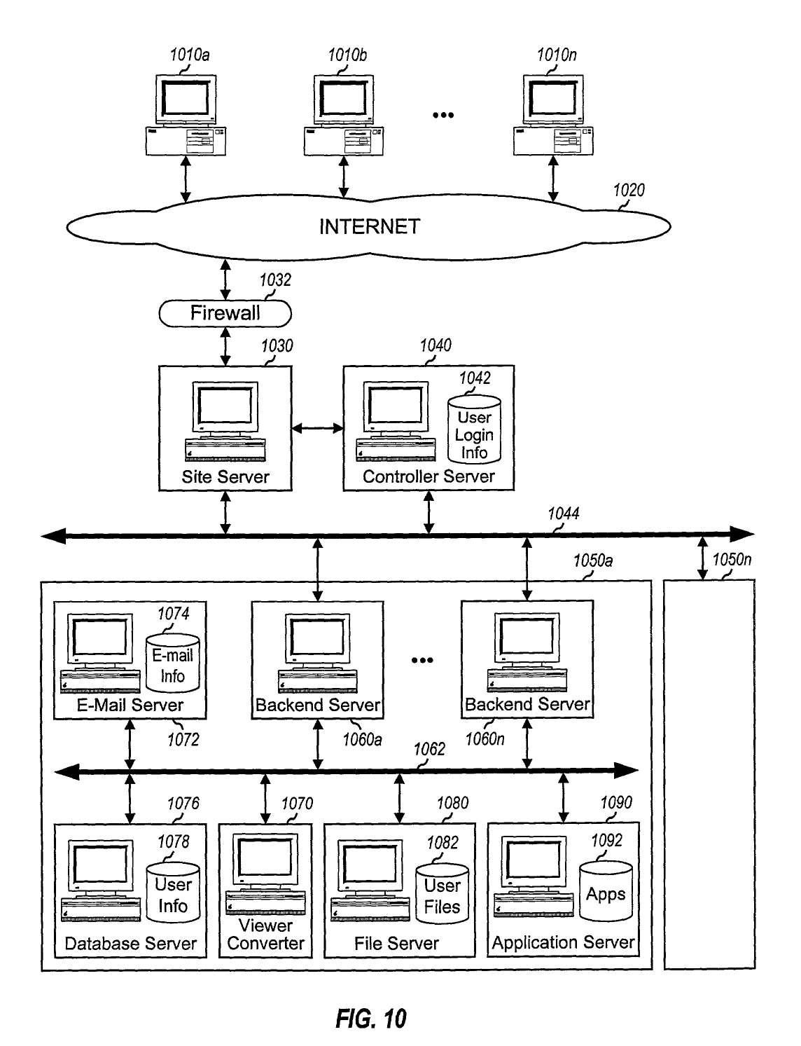

FIG. 10 shows a diagram of an embodiment of a computer network 1000 that implements a virtual computing environment and supports the virtual desktop of the invention. Within network 1000, a number of computer systems 1010 couples to the Internet 1020 through various communications links described above. Computer systems 1010 can represent the various systems depicted in FIG. 9. The Internet 1020 is a collection of networks that allows files and resources on computers interconnected to the networks to be shared. A site server 1030 also couples to the Internet 1020 through a firewall 1032. Firewall 1032 provides a security wall between site server 1030 and the Internet 1020 and is discussed in further detail below.

Site server 1030 is a Uniform Resource Locator (URL) site (e.g., MAGICALLY.COM) to which computer systems 1010 connect. Site server 1030 processes a user's login, which typically includes receiving the user's identification and password. Site server 1030 couples to, and provides the login information to, a controller server 1040. Controller server 1040 checks the login information against a database 1042 of login information to determine whether the user is authorized for access to the network. If the user is authorized, controller server 1040 determines the appropriate Hypertext Transport Protocol (HTTP) server to which the user should be directed. In a large network that includes more than one backend server, controller server 1040 directs the user computer system to the appropriate (i.e., the least congested) backend server. In an embodiment, site server 1030 and controller server 1040 are integrated into one server.

Site server 1030 further couples to a bus 1044 that interconnects one or more regional networks 1050. Each regional network 1050 supports a particular geographic area. For example, regional network 1050a can cover a geographic area such as the United States and regional network 1050n can cover another geographic area such as Asia. Within each regional network 1050, a number of backend servers 1060 services the assigned geographic area. Tasks can be received and forwarded for processing by any one of backend servers 1060 then available. Backend servers 1060 further couple to a bus 1062 that also interconnects a viewer converter 1070, an e-mail server 1072, a database server 1076, a file server 1080, and an application server 1090. E-mail server 1072 couples to an e-mail database 1074, database server 1076 couples to a user information database 1078, file server 1080 couples to a user file database 1082, and application server 1090 couples to an application database 1092. Data in databases 1074, 1078, 1082, and 1092 may be stored using, for example, an SQL format that is well known in the art. Also, in an embodiment, converter 1070 and servers 1072, 1076, 1080, and 1090 can be directly coupled to bus 1044.

In an embodiment, e-mail server 1072 is implemented with a combination of a POP3 server and a SMTP server. The POP3 server processes the received e-mail messages, and the SMTP server processes the outgoing e-mail messages.

The functions performed by converter 1070 and servers 1072, 1076, 1080, and 1090 are described in detail below. Further, the functions of backend server 1060, viewer converter 1070, e-mail server 1072, database server 1076, file server 1080, and application server 1090, or a combination of these servers, can be integrated and provided by one or more servers.

The configuration of network 1000 in FIG. 10 provides many advantages, including interconnectivity (i.e., global Internet access) and scalability. For example, additional regional networks 1050 can be added to bus 1044 as appropriate. Also, the regional networks can be reconfigured to cover a smaller geographic area due, for example, to increased demands for the servers within regional networks. Also, additional backend servers 1060 can be added to a particular regional network 1050 as necessitated by traffic demands. Regional network 1050 is also scalable by adding additional converters, file servers, and application servers as necessary.

Virtual Desktop

The invention provides a virtual desktop in a virtual computing environment such that a user sees the same desktop and has access to the same applications, files, and amenities independent of the particular computer system on which the access is gained. The user is also provided with tools that allow the user to customize the desktop to whatever configuration the user finds preferable. The virtual desktop is provided through a web browser, or similar applications, that interfaces the user with a backend server on a network such as the Internet.

Numerous advantages can be realized through a virtual computing environment wherein the network provides many of the functions and features of the computer. First, the user enjoys a ‘virtual’ desktop work environment regardless of the computer through which access is gained to the Internet. Familiarity with a particular desktop can enhance efficiency and improves productivity. Second, because of the ubiquitous nature of the Internet, the user is able to gain access to a familiar computing environment through numerous means and from almost anywhere. This effectively provides the user with global access from the home, office, while on travel, and so on. Third, the virtual work environment allows the user to have access to the same files and resources from anywhere. This allows the user to work on a particular document using a particular application from virtually any location with Internet access. Additional features are also provided by the invention by virtue of the integration of the resources. For example, the invention can provide an automatic file backup system, file synchronization, and so on, which are discussed below.

In illustrating the invention with respect to its implementation in conjunction with a web browser application (or browser), a few terms will now be defined. A Universal Resource Locator (URL) is a well-known element widely used in communications systems that make up the World Wide Web (or web). URL is used as an identifier to point to a specific site or location of a computer and its contents on the web. A given URL typically points to a Hyper Text Markup Language (HTML) encoded page of data, but it may also point to a text file, an image, or even a moving image stream. The URLs are specified by the user (i.e., through a user interface). The browser is an application program that requests, receives, processes, and presents data pointed to by the URLs. The browser normally selects the appropriate method to process each type of data that is received and then displays an HTML page of the data. The browser has the ability to move in response to the user's direction from one specified URL content to another. For example, if the user selects a link in an HTML page, the browser will access the new URL location pointed to by the link.

In the invention, the user initially activates a browser application program installed on computer system 1010 in FIG. 10. Typical browser application programs such as Navigator™ from Netscape Corporation and Internet Explorer™ from Microsoft Corporation are well known and readily available. The browser is executed by (double) clicking on the browser icon or through other means (i.e., executing the browser from the desktop file management system).

When the browser's main screen comes up, the user enters into a user interface field the URL of the site server that supports the virtual desktop. For example, the user can enter the web site “HTTP//MAGICALLY.COM” and hit the carriage return <CR> key. The user can also activate the URL search by selecting a bookmark under the browser's pull down main menu (i.e., “BOOKMARKS” in the Navigator™ browser). The browser then searches for the web site and retrieves from the appropriate site server a web page corresponding to the entered URL.

The URL site server provides data contents, called a web page, that are processed by the browser and presented for display on the CRT of the user's computer system. The processing can be performed by either the browser's own facilities, facilities provided by the operating system, under which the browser executes, other facilities provided by the applications concurrently executing along with the browser, or a combination of the above. The web page can contain any mixture of text, graphic imagery, pictures, sounds, and even motion picture information. The web page also includes a login window. Upon a successful login, the user's personal web page that displays the virtual desktop is provided to the user's computer system. The login process is described in further detail below.

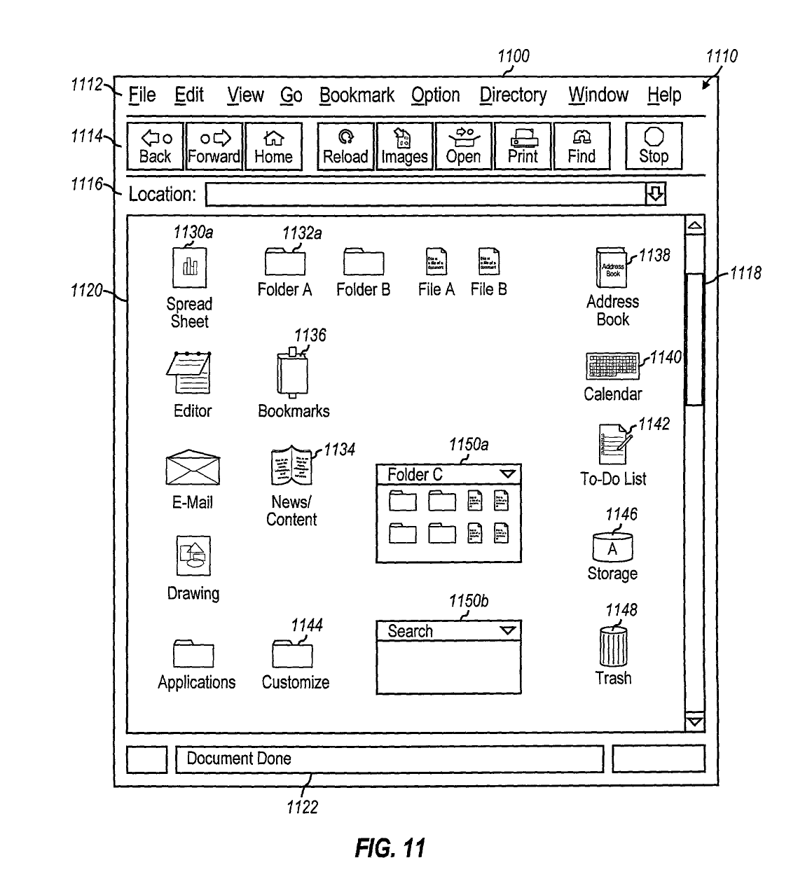

FIG. 11 shows a diagram of a browser display of a representative virtual desktop for a particular user that has been retrieved from the URL web site. A browser display 1100 includes a user interface control area 1110 and a display area 1120. Control area 1110 can include pull down menus 1112, an array of functionally selectable buttons 1114, a typing field 1116, and a scroll bar 1118 that enables the user to scroll through the page(s) in display area 1120. Additional information, icons, control functions, and the like can also be displayed in control area 1110. For example, a URL field 1122 can be provided at the bottom of display 1100 to indicate the URL associated with a link in display area 1120 whenever the user passes the mouse pointer over the link. Control area 1110 can be rearranged or reconfigured, to an extent as allowed by the particular browser application, based on the user's preference. However, changes made to control area 1110 are generally localized to the particular computer system on which the browser is installed.

Display area 1120 represents the virtual desktop of the user and can be customized according to the user's needs and preferences. As shown in FIG. 11, display area 1120 includes icons 1130 for applications available to the user, icons 1132 for folders and files, an icon 1134 for sources of news and information, an icon 1136 for browser bookmarks, an icon 1138 for an address book, an icon 1140 for a calendar, an icon 1142 for a to-do list, an icon 1144 for customization tools, an icon 1146 for storage, an icon 1148 for trash, and windows 1150 that pop up on display area 1120 based on selections by the user. The various icons enumerated above can be replaced or supplemented with toolbars, lists, objects, or other indicators that identify the underlying items for which they represent. Application icons 1130 can be provided for applications such as word processing (e.g., Word™ and WordPerfect™), spread sheet (e.g., Excel™ and Lotus123™), presentation (e.g., PowerPoint™), e-mail, and others. The various trademarked products are from Microsoft Corporation and Lotus Corporation. Display area 1120 can also have a wallpaper background selected by the user based on personal preference.

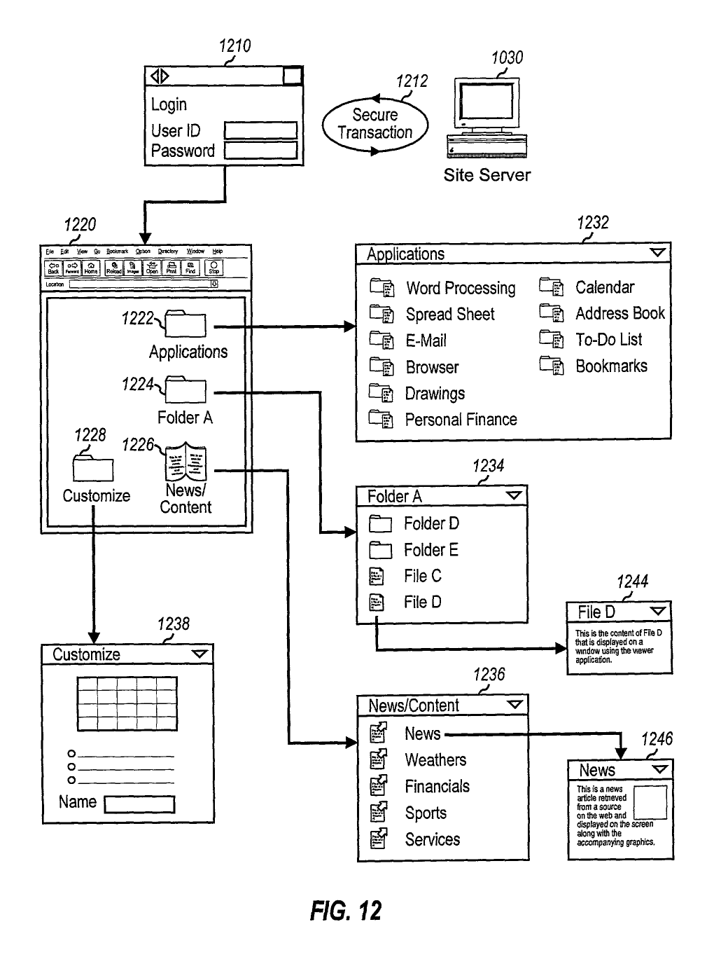

FIG. 12 shows, in summary form, some of the processes and features provided by the virtual desktop of the invention. As shown in FIG. 12, the web page from the site server initially includes a login window 1210 that prompts the user for an identification and a password. The user then enters the requested information in the appropriate fields. Upon indicating that the information has been entered (i.e., by hitting the carriage return in the password field), a secured transaction 1212 is initiated with URL site server 1030. The login information is securely transmitted to site server 1030 using, for example, a Secured Socket Layer (SSL) based security technique. Site server 1030 determines whether the user is registered and, if yes, transmits the user's personal web page. The login process is described in further detail below.

After a successful login, the user's personalized virtual desktop 1220 is transmitted, received, and displayed. Desktop 1220 corresponds generally to browser display 300 in FIG. 3. The user can then activate the features of the virtual computer by activating the appropriate icon from virtual desktop 1220. In general, through virtual desktop 1220, the user has access to applications, files, news and information, and additional features.

To execute a particular application, the user (double) clicks on the icon representing that application and, in response, the site server cooperates with the application server to allow execution of the selected application. Depending on the particular application, the application server can transmit applets of the application which are then executed by the browser. The application server can also transmit codes for the application which are then executed on the user's computer system. The application server can also execute the application at the server site and communicates the data and correspondences with the user's computer system. The user may also be given a choice to direct execution of the application on a particular computer or server. Once the selected application is executed, the user interacts with the application in similar manner as if the application is executing on the user's computer. The user is practically unaware of the difference in the computing environment.

The applications available to the user can also provide other features and amenities. For example, by clicking on an application icon 1222, a list of available applications is displayed on a window 1232. This list may include, for example, icons for a calendar, e-mail, to-do list, address book, bookmarks, browsers, and so on.

The user can manage files and folders through a file management system provided by the virtual computing environment. Because of the extensive interconnectivity associated with the Internet, the file management system provides additional advantages and features not normally associated with a stand-alone computer or a local area network. For example, separate folders can be provided for the user's private files, public files, and limited access files. These file types have different attributes. These and other features of the file management system are described in further detail below.

To activated a folder, the user simply (double) clicks on a folder icon 1224. A window 1234 then appears which contains the files and folders associated with the selected folder. A folder within window 1234 can then be selected and, in response, an additional window appears which contains the files and folders associated with that selected folder. Alternatively, window 1234 can be refreshed with the contents of the selected folder each time a folder is selected. If the user selects a file, a viewing window 1244 appears which displays the data in the selected file.

An advantage provided by the Internet-based computer network is the ability to easily gather news and information from various web sites. As such, virtual desktop 1220 can include icons corresponding to, or including, URL links to news and content sources. The user can access the sources by (double) clicking on a news icon 1226 that then opens a window 1236. Window 1236 can include URL links to other web sites. Each link is associated with the URL of another web page on the web. The URL links appear to the user as text that is highlighted in some manner, such as underlining and/or colored text. The URL links can be arranged by category, in alphabetical order, or by other arrangements based on user preference. By selecting the link with the mouse or other pointing device, the user can move to a web page corresponding to the selected link which is displayed in a window 1246. The operation of the news/content aspect of the invention is described in further detail below.

The virtual desktop layout and configuration can be tailored to the user's particular preference. Customization of virtual desktop 1220 can be initiated by (double) clicking on a customize icon 1228 that activates a customize window 1238. Customize window 1238 includes the tools and features that allow the user to customize the virtual desktop. The operation of the customization feature of the invention is described in further detail below.

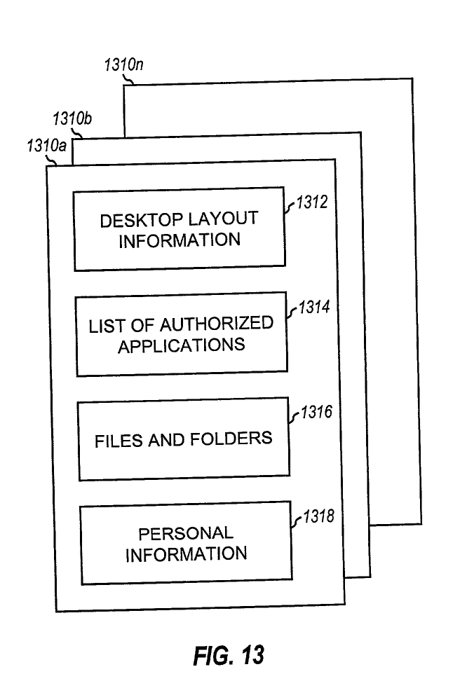

FIG. 13 shows a diagram of an embodiment of the data stored for the users in the virtual computing environment. Referring back to FIG. 10, data associated with the users is stored in one or more databases, including user login information database 1042, e-mail database 1074, user information database 1078, and user file database 1082. The information associated with each user can be represented by a data record 1310. Data record 1310 includes, for example, virtual desktop layout information 1312, a list of applications 1314 that the user has been authorized for access, files and folders 1316, and personal information 1318. Additional types of data can be stored for each user. Also, the data size for each data type can vary from user to user based on, for example, a particular user's requirements. The number of files and the total storage area typically vary among users. The number of applications authorized and the amount of available storage space may further be dependent on, for example, payment of a service fee.

Although the data for each user is shown as being integrated to a single data record, the data within the record may, in actuality, be stored in separate databases. For example, the desktop layout information, the list of authorized applications, and the personal information for all users may be stored in user information database 1078, and the files and folders may be stored in user file database 1082. Alternatively, the entire record may be stored on one database at a central server.

File Management

The file management system allows the user to manipulate files and folders in similar manner as for a desktop PC, including create, save, rename, delete, copy, cut, paste, find, and so on. In addition, because the files are maintained in a network environment, the invention provides other file manipulation capabilities not available on the desktop PC, including file sharing, access control, and others. The invention also provides additional features through a high level of integration between the file management system and the applications, as explained below.

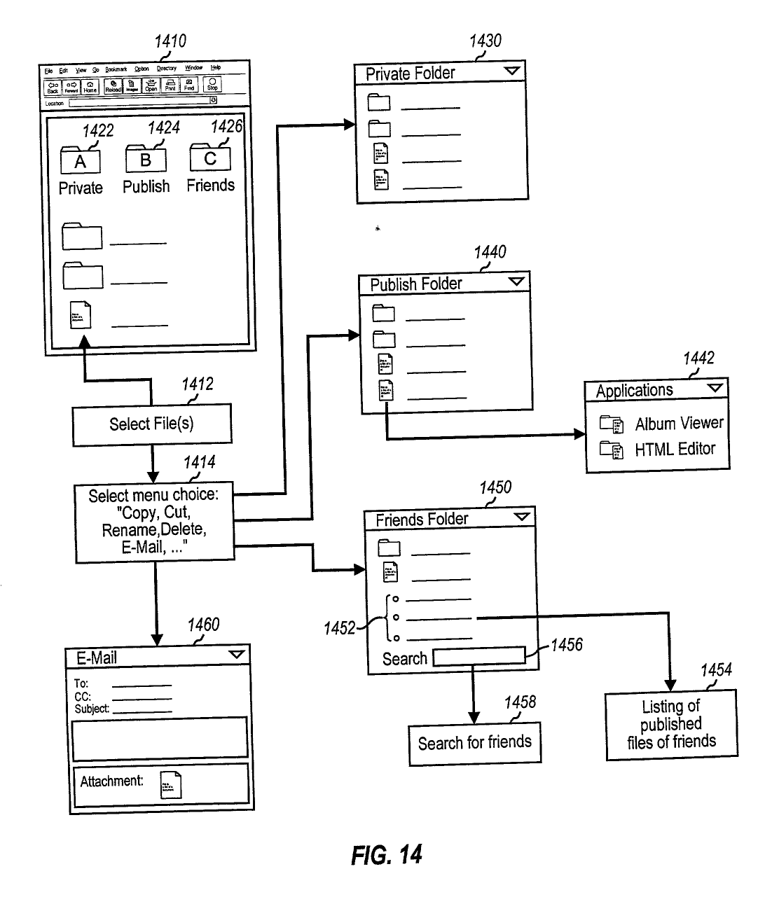

FIG. 14 shows a diagram of some of the processes of the file management system of the invention. A virtual desktop 1410 includes a number of files and folders created by the user and the system. Desktop 1410 generally corresponds to window 300 in FIG. 3 with the other icons not shown for clarity. The files and folders can be displayed using various formats including large icons, small icons, listings, or a combination of the above.

The user selects a particular file or folder in file window 1410 by (double) clicking on the particular item (as indicated at 1412). Upon making the item selection, a window appears which enumerates the available menu choices for the selected item (as indicated at 1414). For example, the user can create a duplicate of the selected item, make a copy of the selected item into another folder, and so on.

Because of the interconnectivity provided the Internet-base computer network of the invention, additional file management features are available. For example, files and folders may be shared between users connected to the network. The invention provides techniques to control access to files. Access rights includes, for example, no access, read access, write access, and full access. Also, files may be accessed and manipulated by one or more authorized users, even concurrently, and techniques are provided to maintain the files. Some of the files, and their contents, can also be freely transferred through the web. URL links can also be generated to allow external access, through the Internet, to some of the files.

In an embodiment, for each user, the network maintain three separate folders labeled as secure (or “private”), open (or “publish”), and limited access (or “friends”), as shown in window 1410 in FIG. 14. However, greater or fewer number of folders can be provided and is within the scope of the invention. An appropriately identified icon in window 1410 represents each of these three folders. A private folder icon 1422 represents the private folder, a publish folder icon 1424 represents the published folder, and a friends folder icon 1426 represents the limited access folder.

The private folder is accessed by clicking on private folder icon 1422 to open a private folder window 1430. The private folder contains protected files that are accessible only by the authorized users. No URL links are provided to files in this folder. No access is possible to files in the private folder from the Internet, except from the virtual desktop of the authorized user. The private folder can include a multi-level listing (e.g., a file located within a folder that is located within another folder, and so on).

The public folder is similarly accessed by clicking on publish folder icon 1424 to open a publish folder window 1440. The public folder contains unprotected files that are freely accessible by everyone (i.e., with full read access). A file in the publish folder can be associated with a URL link, and FTP access to the files is also available. Files in the publish folder are to be shared between all who have access to the network. The publish folder can also include a multi-level listing.

Files in the publish folder may be associated with additional features not available or appropriate for other file types, and additional menu choices can be provided to activate these features. By clicking on a file or folder in window 1440, a menu screen 1442 appears which lists the possible application choices. The choices can include, for example, an album viewer and a HTML editor that facilitate the creation of a public homepage for the selected file.

The limited access folder is accessed by clicking on friends folder icon 1426 to open a friends folder window 1450. The limited access folder contains protected files that are accessible only by those specifically authorized by the user. The extent of the access is also limited to the rights granted by the user, which may include read only, read and write, and others. Each limited access file can be individually tailored with different rights granted to different “friends.” For example, friend A may be granted read only access to file X, friend B may be granted full access to the same file, and so on.

Window 1450 can also contain a list 1452 of links to other friends (e.g., other users who are denoted as friend by this user). By clicking on a particular link in list 1452, a window 1454 opens which lists the files available to this user from the friend associated with the link. The user clicks on a friends link listed in window 1450 to see a list of publish files available from that friend, and also a list of the limited access files from that friend that are available for access by this user. Window 1450 also contains a search and query box 1456 that allows the user to search for other users who consider this users as their friend. A window 1458 would then appear that lists the results of the search.

Because of the integration provided by the invention, additional file manipulation features are available. For example, in box 1414, a menu choice can be provided to e-mail the selected file or folder. By selecting this menu choice, the e-mail application is conveniently activated and a window 1460 for a new e-mail message is generated. The e-mail message automatically includes the selected file or folder in the attachment section. The user then simply enters the recipient's address and sends off the message.

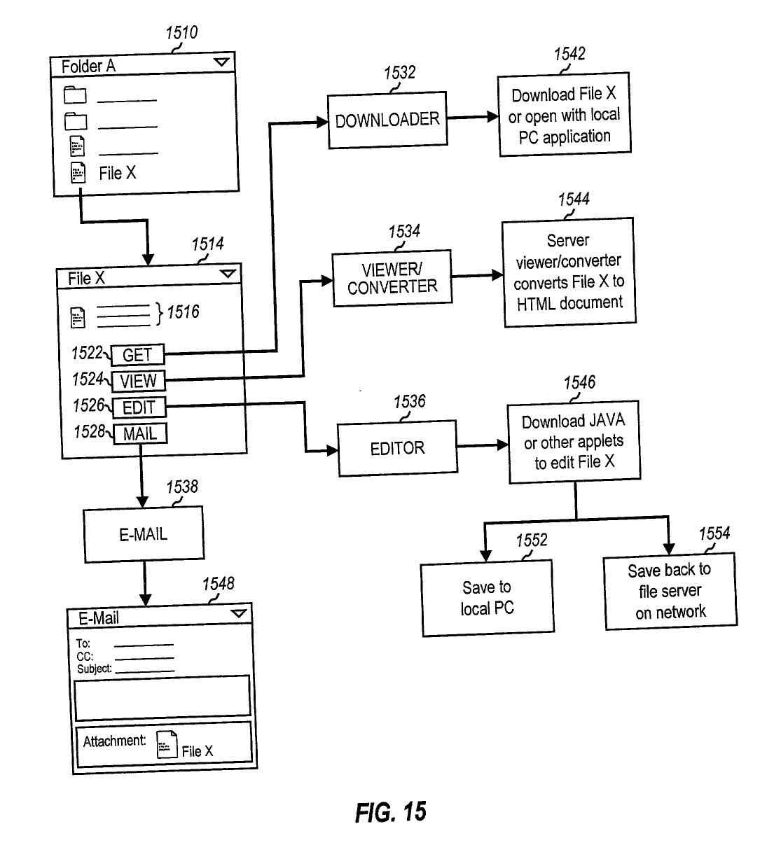

FIG. 15 shows a diagram of additional processes of the file management system of the invention. A file window 1510, corresponding to window 1234 in FIG. 12, appears on the user's virtual desktop by (double) clicking on a file icon on the virtual desktop. File window 1510 includes a listing of the files and folders within the selected folder. By clicking on a particular file or folder, a window 1514 appears that includes the available menu choices for the selected item. As shown in FIG. 15, a File X is selected.

File window 1514 can include, for example, a listing 1516 of information on the selected file such as the file version, the file type (e.g., a word processing, spreadsheet, or other document types), the size of the file, who created it and when, who last modified it and when, who has access rights to it, whether a payment must be made to use the file, and so on. File window 1514 can also include buttons that indicate the menu choices available for the selected file, such as get, view, edit, mail, and so on.

By clicking on a get button 1522, a downloader 1532 is activated which initiates a download of the selected file (i.e., to the user's computer system or the local PC), as indicated by at 1542. The downloader can also open the selected file with a local PC application as indicated by the file information. The downloaded file can be printed, copied, edited, or otherwise processed.

By clicking on a view button 1524, a viewer/converter 1534 is activated. Viewer/converter 1534 is typically resident on the application server and invoked when selected. Viewer/converter can, for example, convert the selected file into an HTML file, as indicated at 1544. Viewer 1534 can also convert, for example, a PowerPoint™ presentation into a JPEG file, a WordPerfect™ document into a HTML file, and so on. Once the file is converted into the destination format (e.g., HTML or JPEG), it can be easily manipulated by standard applications designed to operate on these file formats. The converted files can also be printed, viewed, copied, and so on.

By clicking on an edit button 1526, an editor 1536 is activated. The editor can be written with JAVA™ or other programming languages (i.e., using applets) that can be downloaded onto the local PC for execution, as indicated at 1546. Editor 1536 can also download a selected file (if any) onto the local PC for manipulation by the user. An edited file can be saved to the local PC (as indicated at 1552) or back to the user's storage space on the network (as indicated at 1554), or both. In an embodiment, while a file is being edited, it is temporarily stored along with the application (i.e., on the local PC) to provide faster access speed. Periodically, the file can be copied back to the network where file backup can be performed.

Alternatively, editor 1536 can (already) reside within the local PC and activated when the user clicks on edit button 1526. The selected file, if any, can be downloaded onto the local PC for editing. After the file is closed, a copy of the edited file can be uploaded back to the network for storage.

For some situations, it may be more advantageous to execute the editor at the application server. This may occur, for example, if the amount of data to be manipulated is small. In this case, a portion of the editor (i.e., the viewer) can be downloaded onto the local PC (if none already exits). As the file is edited, changes are downloaded onto the local PC for display. Commands from the user are received from the local PC and transmitted to the application server for processing.

By clicking on a mail button 1528, an e-mail application 1538 is activated. E-mail application 1538 can display an e-mail message window 1548 that conveniently includes the selected file as an attachment. The user then simply fills in the appropriated fields (e.g., TO, CC, and SUBJECT fields) in window 1548 and hits the send button. This feature is particularly convenient for the web-based computer network of the invention.

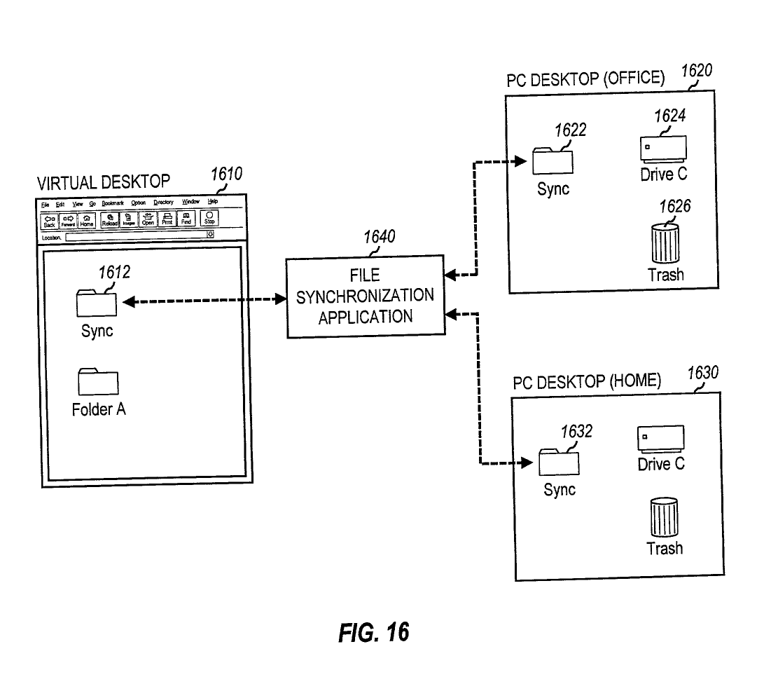

FIG. 16 shows a simplified diagram of an embodiment of the file synchronization feature of the invention. As noted above, files and folders can be easily transferred and shared between the storage on the network and the local PCs (e.g., the office desktop PC, the home desktop PC, or a portable PC) used to access the virtual desktop. File sharing greatly enhances flexibility but requires the file management system to maintain up-to-date copies of the files.

As shown in FIG. 16, a virtual desktop window 1610 includes a sync folder icon 1612. An office PC desktop window 1620 includes a sync folder icon 1622, a hard disk icon 1624, and a trash icon 1626. Similarly, a home PC desktop window 1630 includes a sync folder 1632. The communications between the PC desktops and the virtual desktop is coordinated by a file synchronization application 1640. Although typically one desktop PC accesses the virtual desktop at any give moment, there may be situations when multiple desktop PCs concurrently access the virtual desktop (i.e., such as when files are being shared between two users at two desktop PCs). Windows 1610, 1620, and 1630 typically include other icons that are not shown in FIG. 16 for clarity. Also, more than one sync folder can be created on a particular desktop.

The sync folders on the desktop PCs contain files and folders to be maintained “in sync” with their duplicates on the network. The user is able to access and manipulate the items in the sync folder like any other folders. These items are functionally indistinguishable to the user except for the sync feature.

In an embodiment, if the user maintains a sync folder on the PC desktop and the sync folder has at least one item, the file synchronization application is launched and runs in the background of the desktop PC. At the designated update times, the file synchronization application exchanges with the file server information pertaining to the items in the sync folder. Files are then transferred and updated based on the exchanged information and in accordance with the instructions set by the user, as further described below.

The update times can be designated by the user or selected automatically by the file synchronization application. For example, the user can elect to update the files at the start of a session, at the end of the session, during the session, or a combination of the above. The user can also elect to have the files updated at specific times (e.g., at midnight everyday) or only when the user commands. If no times are designated by the user, the synchronization application can automatically select the update times. The user can also selectively enable and disable the file synchronization feature.

In performing the file synchronization at the designated time, the synchronization application first retrieves information for items in the sync folder. For each item in the folder, the application then compares the last edit time of the item in the PC desktop with its duplicate, if any, on the file server. If the times match, no additional work is performed. Otherwise, if the times do not match, the files are updated in accordance with a method selected by the user. For example, the newer item can be written over the older item, the newer item can be saved as a new version, and so on. The updated item is indicated accordingly (i.e., with a name change, an extension change, or a version change in the file attribute). If a file is recently created and a corresponding duplicate does not exist, the recently created file is duplicated on the other desktop.

The file synchronization feature ensures that the user has access to the most current files at any given moment, and from virtually anywhere web access is available.

Additional Features

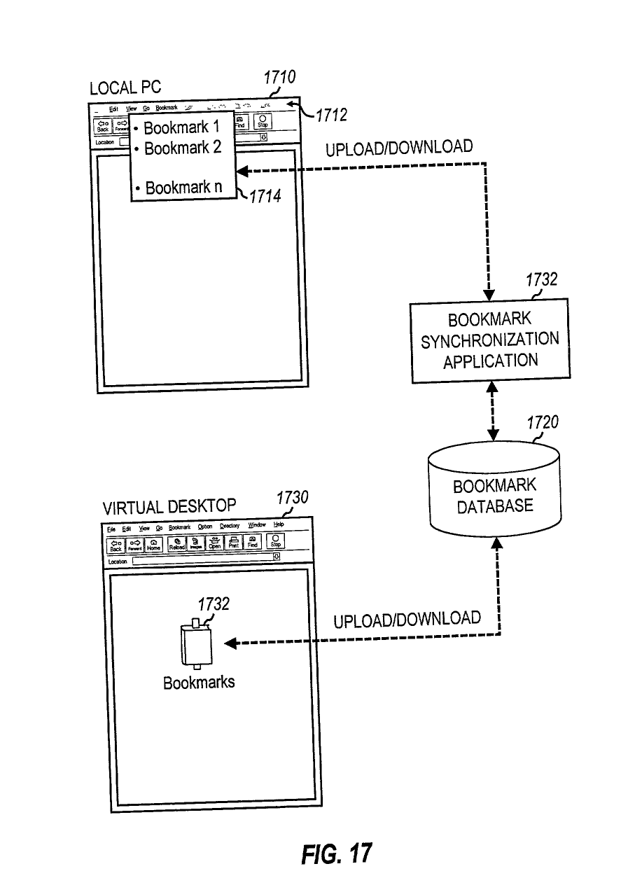

FIG. 17 shows a diagram of an embodiment of the bookmark synchronization feature of the invention. This feature allows the user to have access to the same bookmarks regardless of where and when the bookmarks are created. As shown in FIG. 17, on the local PC, a browser (e.g., Netscape™ or Internet Explorer™) is executed which opens a browser window 1710. Window 1710 includes a pull down main menu 1712 that lists, among other menu choices, the “Bookmark” or “Favorite” menu choice. By clicking on the Bookmark menu choice, a window 1714 pops up that lists the bookmarks previously saved by the user. The user is then able to scroll through the bookmarks, click on a particular bookmark, and the URL corresponding to that bookmark is launched.

Conventionally, bookmarks are local to the PC, or more specifically, local to the browser that is installed on the PC. It is generally a time consuming process to search for a particular website. Also, the bookmarks corresponding to the URLs are typically named (i.e., by the user or the browser) with descriptive names for ease of recognition. Thus, it is advantageous to provide the user with access to the same set of up-to-date bookmarks regardless of the computer from which access to the virtual desktop is gained.

In an embodiment, a bookmark database 1720 stores the bookmarks of the user. Bookmark database 1720 can reside in file server 1080 in FIG. 10. The bookmarks in database 1720 are uploaded to, and downloaded from, a virtual desktop 1730 at the designated times. This allows the user on the local PC to have access to a familiar set of bookmarks on the virtual desktop. On virtual desktop 1730, the bookmarks are contained in a bookmark folder 1732.

The bookmarks in database 1720 can also be uploaded to, and downloaded from, the local PC. Upon activation by the user, a bookmark synchronization application 1732 is executed and runs in the background on the local PC. At the designated times, application 1732 “grabs” the bookmarks from database 1720 and loads the local PC with the retrieved bookmark information. Thus, the bookmarks on the local PC are synchronized with the bookmarks on the virtual desktop. The browser loaded on the local PC, including Netscape™ and Internet Explorer™ can also have access to the bookmarks. The bookmarks are freely transferable between the local and virtual desktops, and also between the different browser applications.

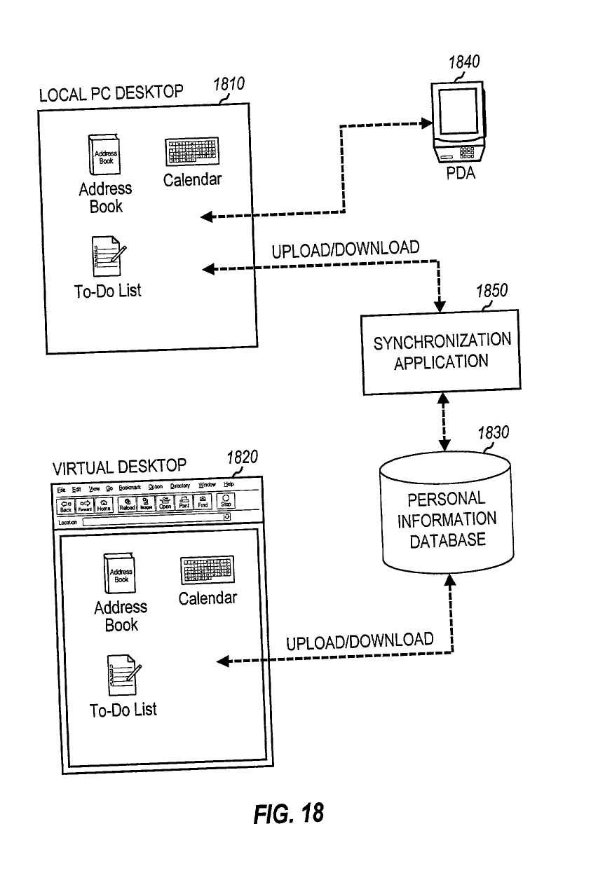

FIG. 18 shows a diagram of an embodiment of some of the features provided by a personal information manager of the invention. The personal information manager maintains a database of information personal to the user, including a calendar, an address and contact book, a to-do list, and other information. Similar to the files and bookmarks, it is advantageous to maintain up-to-date personal information in a central location that is accessible from virtually anywhere.

As shown in FIG. 18, a local PC desktop 1810 and a virtual desktop 1820 each includes a combination of icon, folder, or enumerated list of personal information of various types. For example, icons or folders can be generated that identify the user's address book, calendar, and to-do list. The user can access each type of information by clicking on the designated icon. A window is then opened that displays the selected information.

In an embodiment, a personal information database 1830 stores the personal information of the user. Personal information database 1830 can reside in file server 1080 in FIG. 10. The personal information can be transferred between database 1830 and desktops 1810 and 1820. The personal information can further be transferred between local PC desktop 1810 and a personal digital assistance (PDA) 1840 such as a PalmPilot™, a Windows CE™, or other (hand-held) units.

When enabled by the user, a synchronization application 1850 runs in the background on the local PC. At the designated times, application 1850 updates the personal information on the local PC with the information from database 1830. In this manner, the personal information on the local PC is synchronized with that from the central database.

News, Information, and Services

The virtual desktop and virtual computing environment of the invention provide an integrated link to the vast amount of information on the Internet. Through the virtual desktop, the user is able to quickly and conveniently access other URL links on the Internet. The results gather from the URL links can be manipulated using the applications and tools available on the virtual desktop.

Referring back to FIG. 12, virtual desktop 1220 includes icon 1226 that represents links to sources of news, information, and services. By clicking on icon 1226, window 1236 appears. Window 1236 can also include folders and URL links to other web sites. The user is able to sort the URL links by category, alphabetical order, chronological order, or some other arrangements. When the user clicks on the highlighted URL link in window 1236 (or in a folder within window 1236), the web page corresponding to that site is retrieved and displayed (i.e., on window 1246). The user can then enlarge window 1246 for a larger display.

The contents within window 1246 appear as data that can be manipulated by the user similar to data from other files. Thus, the user can select a section or all of the data in window 1246 and saves it as a new file, or paste it onto an existing file. The user can also print, perform searches, and otherwise manipulate the data in window 1246.

Customization

The virtual desktop can be customized in accordance with the needs and preferences of the user. As part of the customization, the user can change the layout of the virtual desktop, the contents of the virtual desktop, the icon picture, the destination of the query box, the number of items on the desktop, the color of the windows, boxes, and toolbar, and so on. A database of pre-built objects can be provided to assist the user in customizing the desktop.

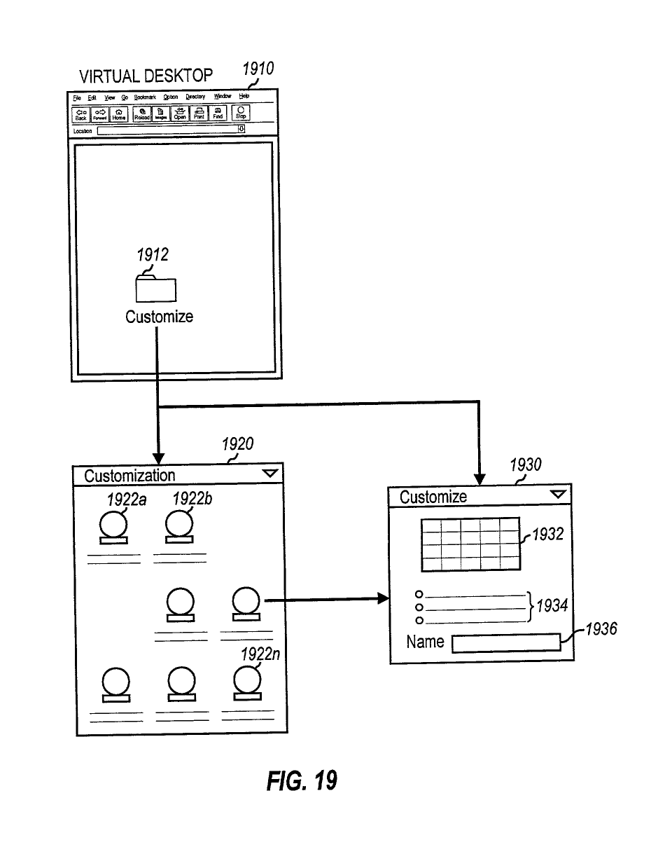

FIG. 19 shows a simplified diagram of an embodiment of the customization process for the virtual desktop of the invention. Within a virtual desktop 1910, a customize icon 1912 is provided that includes the tools available to assist the user in customizing the desktop.

In an embodiment, virtual desktop 1910 is partitioned into a grid of blocks. Each block in the grid corresponds to a desktop object. Each desktop object represents an application, a file, a folder, a personal document (e.g., address book, calendar, to-do list), or so on. By (double) clicking on customize icon 1912, a customization window 1920 appears. Customization window 1920 includes a number of desktop objects 1922, one for each block of the grid that has been assigned with an object. The user can create, arrange, or delete objects within the desktop as necessary. For example, similar to many PC desktops, the virtual desktop can include objects associated with word processing, spreadsheet, e-mail, and other applications. By clicking on a particular desktop object 1922, a customize window 1930 appears which includes the tools to modify the selected object.

In another embodiment, the user is able to customize by adding and otherwise modifying items of the virtual desktop (i.e., without reference to the grid). In this embodiment, to edit or modify a particular icon, the user clicks on customize icon 1912 and window 1930 appears.

Window 1930 includes, for example, an icon listing 1932, an item description listing 1934, and a query box 1936. Icon listing 1932 includes the icons of the applications available to the user, icons for files and folders, and icons for other features of the desktops (e.g., calendar, address book, and others). The user selects an icon to be associated with the selected object. Subsequently, the user is able to activate the object (i.e., launch an application) by clicking on the icon. Item description listing 1934 includes items associated with that object (e.g., to-do events, bookmarks, and so on). Query box 1936 allows the user to search for particular items. For example, for the e-mail application, query box 1936 can be used to search for e-mails from a particular recipient, e-mails sent on a particular date, and so on. Query box 1936 can also be coupled to an Internet based search engine to allow the user to search for news, information, and services on the web.

Security

Because the network stores the user's files and personal information, security is an important feature of the invention. In particular, security is provided during a session with the network and in the maintenance of the files. The user is allowed, to an extent, to choose the level of security to be maintained.

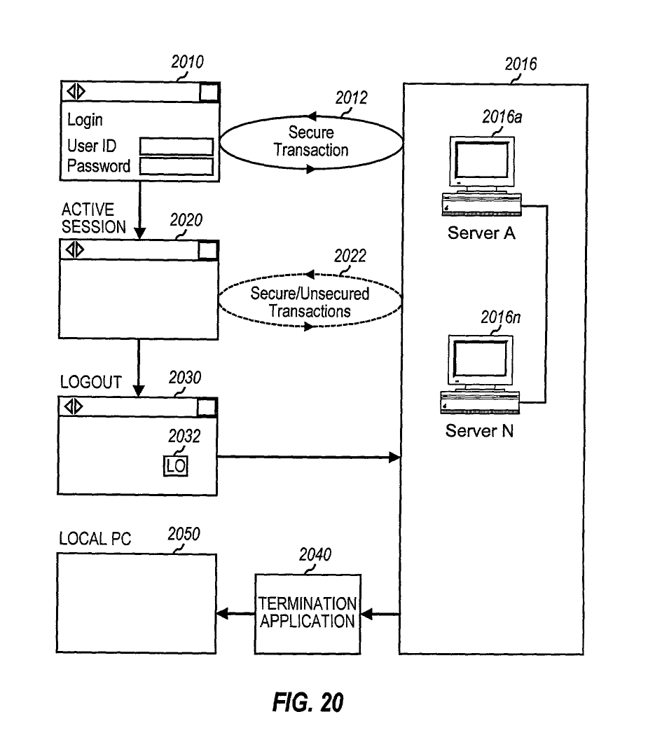

FIG. 20 shows a diagram of an embodiment of the security provided for the virtual desktop of the invention. The first level of security is provided by the use of a secured login process. During the login process, a login window 2010 appears on the web page of the URL site server. Login window 2010 includes fields for the user identification and the user password. The login information is entered by the user and transmitted to the site server where it is compared with the information in a login database. The user is only granted access if the login information match. The login is typically performed as a secure transaction 2012 using, for example, a secured socket layer (SSL) that is defined by IEEE and ISO standards and supported by the browser application. Servers 2016 include collectively the site server, the backend servers, and other servers that may be contacted during a session.

Once logged in, the user is granted access to the user's virtual desktop. As shown in FIG. 10, firewall 1032 exists between the Internet 1010 and site server 1030. Firewall 1032 supports transactions that use HTTP/FTP protocol. As a choice, the user is allowed to select encryption for the login process only, or encryption for the entire session. Thus, during an active session, the transactions can be secured or unsecured, which is indicated by dashed lines for transactions 2022. If full encryption is selected, each transaction between the local PC and the site server is a secured process. Full encryption may slow down the communications between the local PC and the site server because of the extra encryption processing, but provides a secured computing environment. Additionally, a virus check can be performed on files before the upload (and download) from the local PC to the network.

To terminate the session, the user logs out by clicking on a logout (LO) icon 2032 on a virtual desktop 2030. The logout command is sent to servers 2016. In an embodiment, as part of the logout process, servers 2016 execute (or direct execution) of a termination application 2040 which clears the RAM on the local PC 2050 and the hard dish cache so that “ghost” copies of files are destroyed upon termination of the session. Termination application 2040 can reside on the local PC (i.e., as part of the local PC operating system) that is activated by servers 2016.

Virtual Desktop Processes

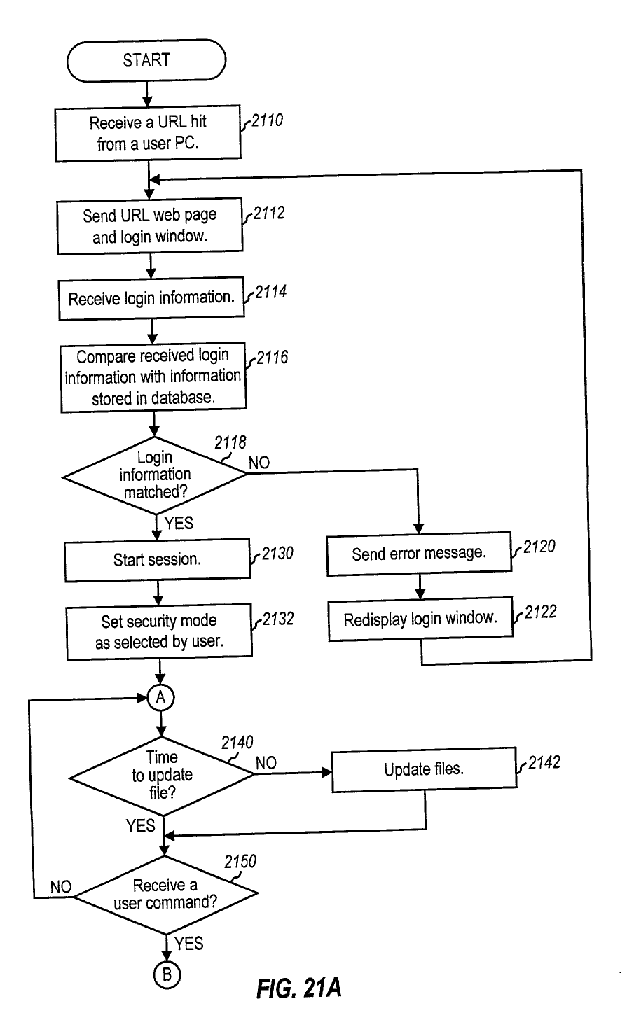

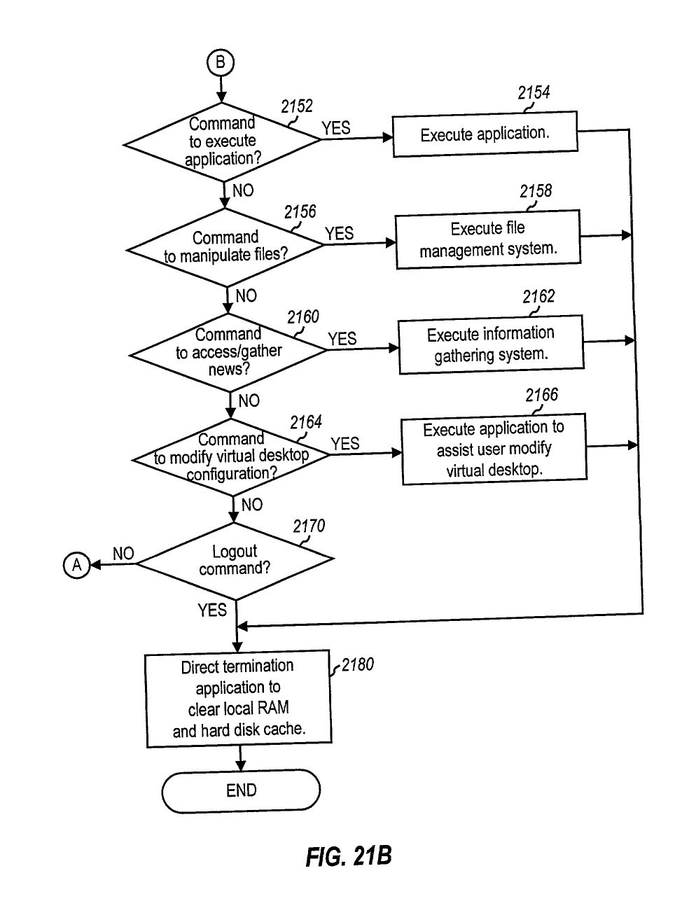

FIGS. 21A and 21B show a flow diagram that describes an implementation of an embodiment of the virtual desktop of the invention. The flow diagram describes implementation of some of the features recited above. Thus, FIGS. 21A and 21B should only be taken as representative, and not limitation, of the invention.

In FIG. 21A, at step 2110, the URL website that supports the virtual desktop receives a URL access from one of the local PC. In response, the URL sends its web page and a login window, at step 2112. Shortly thereafter, the URL receives, at step 2114, the login information and compares, at step 2116, the received login information with the login information stored at the URL for that user. At step 2118, a determination is made whether the received login information is valid. If the received login information is not valid, an error message is sent to the local PC, at step 2120, the login window is redisplayed, at step 2122 (i.e., with the previously entered data removed from the login window fields), and the site server returns to step 2112.

If the login is valid, the session starts at step 2130. The site server then directs one of the backend server to handle the session with the user. The security mode (e.g., no encryption, partial encryption, or fall encryption), as selected by the user or the server, is then set by the server, at step 2132.

In FIG. 21B, at step 2140, a determination is made whether it is time to update the files (i.e., on the local PC or the virtual desktop). The file update can be part of the file synchronization process. The user, in various ways as described above, can designated the update time. If it is time to update the files, the file synchronization application (in conjunction with the file server) updates the files, at step 2142. Although not included in the flow diagram, it is presumed that the file sync application is already executed and ruling (i.e., at step 2130). If the update time has not arrived, or after a file update, the backend server continues to step 2150 where it is determined whether a user command has been received. If the answer is no, the backend server loops back to step 2140.

Otherwise, if a user command has been received, the backend server proceeds through a series of decisions to determine the type of command received. At step 2152, a determination is made whether the command is to execute an application. If the answer is yes, the selected application is executed by the application server, at a step 2154. Otherwise, at step 2156, a determination is made whether the command is to manipulate a file. If the answer is yes, the file management system is executed by the file server, at step 2158. Otherwise, at step 2160, a determination is made whether the command is to access and/or gather information and news. If the answer is yes, the news gathering application is executed, at step 2162. Otherwise, at step 2164, a determination is made whether the command is to modify the virtual desktop configuration. If the answer is yes, the virtual desktop configuration application is executed, at step 2166. Otherwise, at step 2170, a determination is made whether the command is to log out. If the answer is no, the backend server loops back to step 2140. Otherwise, if the user chooses to log out, the virtual desktop application directs the termination application to clear to local RAM and hard disk cache, at step 2180.

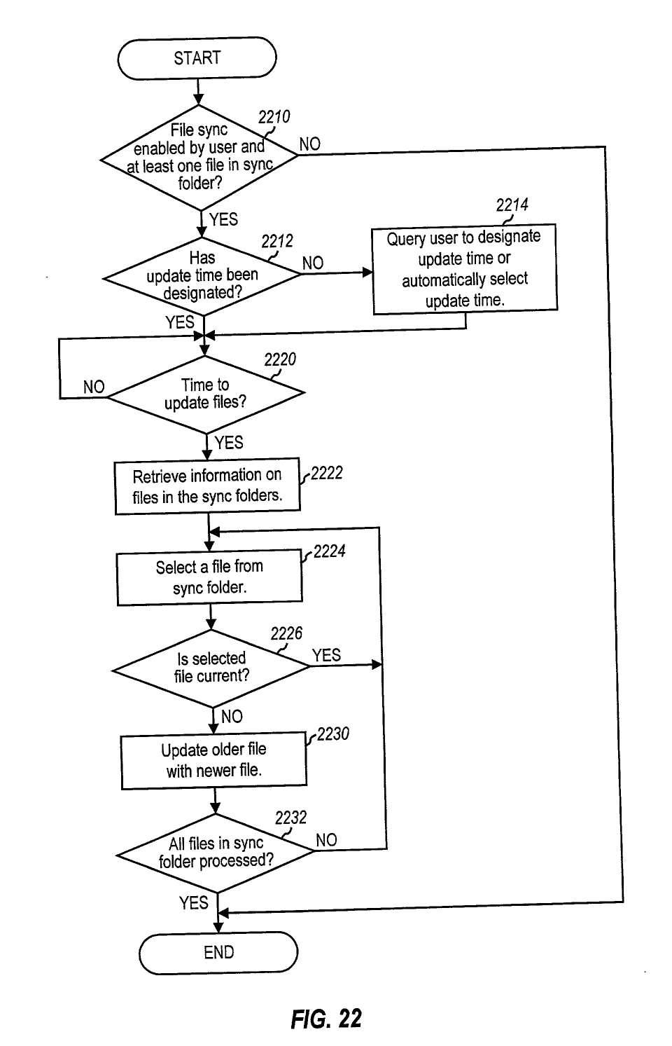

FIG. 22 shows a flow diagram that describes an implementation of an embodiment of the file synchronization of the invention. The flow diagram describes implementation of some of the file synchronization features recited above, and should only be taken as representative, and not limitation, of the invention.

In FIG. 22, at step 2210, a determination is made whether the file synchronization feature is enabled by the user, whether a sync folder exists, and whether the sync folder contains at least one file. If the answer is no to any of these inquires, the file synchronization is not performed. Otherwise, at step 2212, a determination is made whether the update time has been designated. If the answer is no, the user is queried to designate the update time, at step 2214. Alternatively, the file synchronization application can automatically select the update time. The file synchronization application then proceeds to step 2220 where a determination is made whether the update time has arrived. If the answer is no, step 2220 is repeated. Otherwise, if it's time to update the files, the application retrieves information on the files in the sync folder on the local PC and the virtual desktop, at step 2222. At step 2224, a file from the sync folder is selected. A determination is then made, at step 2226, whether the selected file is current. This is performed by comparing the file information and noting the differences, as described above. If the selected file needs updating, at step 2230, the older file is updated with the newer file by either saving the newer file over the older file or saving the newer file as a new version or under a new name. At step 2232, a determination is made whether all files in the sync folders have been processed. If the answer is no, the application returns to step 2224 where the next file in the sync folder is selected. Otherwise, the file synchronization process terminates.

Virtual Desktop Implementation

The invention can be implemented in various manners using various software tools. A specific implementation is described below. However, alternative implementations of the invention can be made and are within the scope of the invention.

In a specific embodiment, the invention is implemented using a set of program modules that are linked together to perform the required functionality. In a specific embodiment, the modules are written using a software tool entitled Active Server Page from Microsoft Corporation. The modules reside within the backend server and are invoked (i.e., in response to a user command) to provide the requested service. A web server application entitled Internet Information Server (IIS) from Microsoft Corporation executes the modules and provides features (e.g., SSL support) used by some of the modules.

Table 1 in the attached Exhibit lists a set of program modules and their functionality. The first column in Table 1 lists the name of the program module, the second column lists the link information, and the third column includes a description of the functionality of the modules. Most of the modules have a .asp extension to denote that they are written using Active Server Page from Microsoft Corporation. In the second column, for each particular module, the upper box lists other modules that link to this module, and the lower box lists other modules that are linked from this module. For example, the login.asp module links to the desktop.asp module. Correspondingly, the desktop.asp module (the third entry in Table 1) is linked from the login.asp module. As shown in Table 1, a module can link to multiple other modules, and multiple modules can link to a particular module.

The third column of Table 1 describes some of the functionality for each module. However, additional features and functionality can be programmed into the modules listed in Table 1, depending on the particular system requirements. Also, additional modules can be programmed and linked to those listed in Table 1. For example, although not explicitly shown in Table 1, modules that facilitate the execution of applications available on the virtual desktop (e.g., Words™, Excel™, Lotus™, and so on) can be written and deployed.

Table 2 lists the interactions between the program modules and the various servers within the network. The modules in Table 1 are listed again in the first column of Table 2. The second through sixth columns in Table 2 correspond to data server 1076, e-mail server 1072, viewer converter 1070, file server 1080, and controller server 1040, respectively. These various servers are shown in FIG. 10.

As noted earlier, the program modules reside in the backend server. Each of the other “specialty” servers (e.g., data server, e-mail server, viewer converter, file server, and controller server) performs a predefined set of tasks. Each of the specialty servers generally includes an “agent” that manages that server and communicates with the program modules residing in the backend server. The agents can be software products manufactured by various vendors, or customized software products written in any programming languages generally available. For example, the data server is managed by an SQL agent available from Microsoft Corporation, the viewer converter is managed by the Outside In Server© product from INSO Corporation, and the secure socket layer (SSL) function of the controller server is performed by a SSL agent from the Internet Information Server (IIS) product from Microsoft Corporation. The Outside In Server application is able to convert files of various formats (e.g., Words™, Excel™, PowerPoint™, Lotus™, Access™, and others) into HTML format for viewing on-line. Generally, no agents are required to manage the file server, as the program modules that access the file server also manage the file server.

The specialty servers are accessed as necessary by the program modules residing in the backend server. Table 2 lists the modules and the servers accessed by the modules, as indicated by the “Y” in the table entry. For example, the login.asp module can access the data server, the file server, and the controller server during execution of the login.asp module.

Table 3 lists the interactions between the program modules and the various databases within the system. The modules in Table 1 are listed again in the first column of Table 3. The second and third columns in Table 3 correspond to the user information database and the desktop database, respectively. The fourth through sixth columns correspond to the e-mail database, the seventh and eight columns correspond to the calendar database, the ninth and tenth columns correspond to the bookmark database, the eleventh column corresponds to the address book database, and the twelfth column corresponds to the friend database. Referring back to FIG. 10, the user information database is implemented in databases 1042 and 1074, the e-mail database is implemented in database 1074, and the remaining databases in Table 3 are implemented in database 1078.

The user information database includes information associated with a particular user, including the login information. The desktop database includes information that define the user's desktop. The e-mail database includes information on the e-mails of the user. In an embodiment, the e-mail database is partitioned into three smaller databases for the e-mail message, the recipient, and the file attachment. The calendar database includes information on the user's calendar, and is partitioned into two smaller databases for the calendar event and the calendar sharing. Calendar sharing database includes the list of users authorized to access and/or update another user's calendar. The bookmark database includes information on the user's bookmark, and is partitioned into two smaller databases for the bookmarks themselves and the bookmark category. The bookmark categories are selectable by the user and are akin to folders for holding bookmarks associated with that user. The address book database includes information on the user's address book. And the friend database includes information on the user's friends.

As shown in Table 3, each module has access to a predetermined number of databases. For example, the login.asp module has read access to the user information database, and the userreg.asp module has read and write access to the same user information database.

In an embodiment, a load balance module tracks the amount of activity on each of the backend servers in the network. The module then determines a distribution of the workload that balances the network and provides good response time to a large number of user. The load balance module then distributes the workload between the backend servers. In an embodiment, the load balance module includes counters that keep track of the amount of processing performed by each of the backend servers.

Computer System

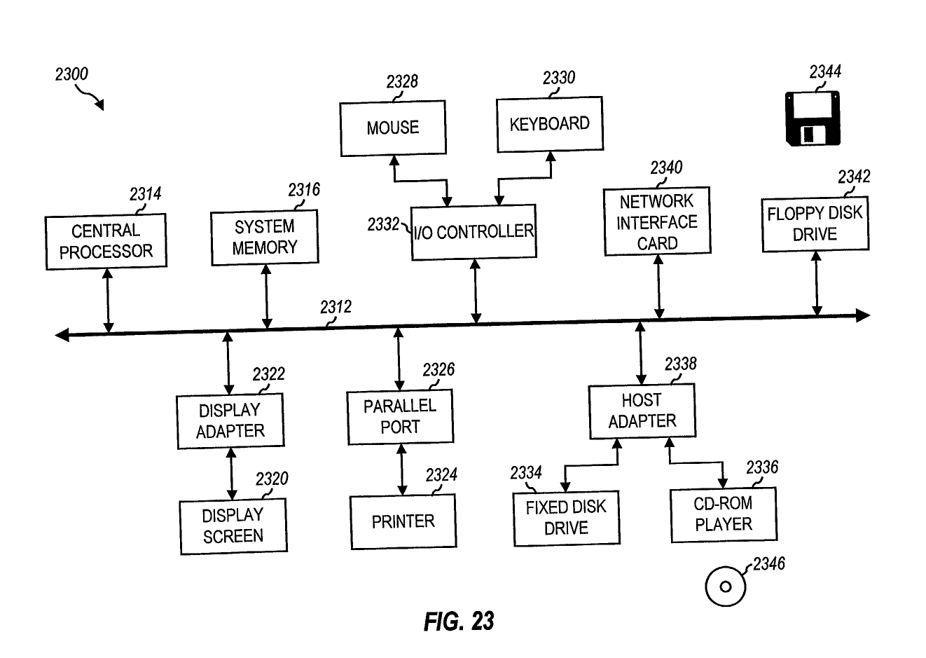

FIG. 23 shows the basic subsystems of a server 2300 suitable for use with the invention. Server 2300 can implement, for example, user terminal 1010, site server 1030, controller server 1040, backend server 1060, viewer converter 1070, e-mail server 1072, database server 1076, file server 1080, and application server 1090 in FIG. 10. In FIG. 23, computer system 2300 includes a bus 2312 that interconnects major subsystems such as a central processor 2314, a system memory 2316, and external devices such as a display screen 2320 via a display adapter 2322, a printer 2324 via a parallel port 2326, a mouse 2328 and a keyboard 2330 via an input/output (I/O) controller 2332, a fixed disk drive 2334 and a CD-ROM player 2336 via a hose adapter 2338, a network interface card 2340, and a floppy disk drive 2342 operative to receive a floppy disk 2344.

Many other devices or subsystems (not shown) can be connected, such as a scanning device, a touch screen, and others. Also, it is not necessary for all of the devices shown in FIG. 23 to be present to practice the present invention. Furthermore, the devices and subsystems may be interconnected in different ways from that shown in FIG. 23. The operation of a computer system such as that shown in FIG. 23 is readily known in the art and is not discussed in detail in the present application. Source code to implement some embodiments of the present invention may be operatively disposed in system memory 2316 or stored on storage media such as fixed disk drive 2334, floppy disk 2344, or a CD-ROM 2346 that is operative with CD-ROM player 2336.

For clarity, the invention has been described in the context of the Internet and for a specific implementation using support products available from Microsoft Corporation. The specific details are intended to be illustrative, and not limitations, of the invention. It will be recognized that alternative implementations of the invention and modifications of the techniques described herein can be made (i.e., to satisfy a particular design requirement). For example, the invention can be implemented within any computing network, including local area network, a campus network, a wide area network, or others. Further, the program modules that implement the invention can be written in other codes (e.g., C, C++, Java, or others). Accordingly, these variations are all within the scope of the invention

The foregoing description of the specific embodiments is provided to enable any person skilled in the art to make or use the invention. Various modifications to these embodiments will be readily apparent to those skilled in the art, and the generic principles defined herein may be applied to other embodiments without the use of the inventive faculty. Thus, the invention is not intended to be limited to the embodiments shown herein but is to be accorded the widest scope consistent with the principles and novel features disclosed herein, and as defined by the following claims.

TABLE 1
Exhibit A
Virtual Desktop Program Modules

| | Link to | | |
|---|---|---|---|
| Module Name | Link from | Module Functional Description | |
| login.asp | desktop.asp | performs user authentication—the user is asked to enter the User ID and Password; if | |
| | | matched, the user is allowed to enter the system; there is also a link for new user registration | |
| | | and a quick tour | |
| userreg. asp | | performs user registration—the user fills in the required information, choose User ID and | |
| | login.asp | Password, and may subscribe to additional premium services such as extra POP3 (e-mail) | |
| | | accounts, extra file storage, file viewer/converter, synchronization features, and others | |
| desktop.asp | * | displays desktop objects for the user—objects can be internal functions, external hyperlinks, | |
| | login.asp | forms to submit data to external sites, any user-defined html, and others; the user can place | |
| | | any of these objects to any of the allowed positions on the desktop; the user can also define | |
| | | the color of the banner and background of each object | |
| desktopwiz.asp | desktop.asp | assists in customization of the desktop—desktop configuration is done by a set of wizard like | |
| | desktop.asp | procedures; the module first asks the user which desktop item is to be configured and the | |
| | | type of desktop object (object types can be internal functions, external hyperlinks, forms to | |
| | | submit data to external sites, any user-defined html, or others); it then asks the color of the | |
| | | banner and background of each object; it also asks if there is any extra description about the | |
| | | desktop object to be displayed on the desktop | |
| msgnew.asp | attach.asp | composes a message—the message can have file attachments from local hard disk or from | |
| | addbooklookup.asp | the file server; e-mail addresses of recipients and cc can be looked up from the address book | |
| | desktop.asp | | |
| | menu2.asp | | |
| msgin.asp | msgindetail.asp | lists messages from inbox, folders, and trash—message can be sorted by subject, sender, sent | |
| | fileattdetail.asp | date, or by unread messages; if any message is unread, a red flag is placed in the beginning | |
| | menu2.asp | of the message line; messages can be filed in folders or trashed by pressing a “move to” | |
| | | button in the menu; user can download file attachments to local hard disk or save it to the file | |
| | | server | |
| msgindetail.asp | msgin.asp | displays details of a message—the user can choose to reply to the message or forward the | |
| | caleventnew.asp | message to others; the user can also file the message in folders or trash it; any recipient or cc | |
| | todonew.asp | in the message can be added to the dress book; the user can download file attachments to | |
| | addbooknew.asp | local hard disk or save it to file server; if the message content contains hyperlinks, a | |
| | fileattdetail.asp | bookmark label prefixes the hyperlink; the user can click on this label to add this hyperlink to | |
| | bookmarknew.asp | the user's own bookmark | |
| | msgin.asp | | |
| msgreply.asp | attach.asp | functions in similar manner as compose mail—except that it carries along the message | |
| | addbooklookup.asp | contents and the replying recipients/cc from the original message | |
| | msgindetail.asp | | |
| | msgindetail.as | | |
| msgfwd.asp | attach.asp | also functions in similar manner as compose mail—except that it carries along the message | |
| | addbooklookup.asp | contents and file attachments from the original message | |
| | msgindetail.asp | | |
| | msgindetail.asp | | |
| msgresend.asp | msindetail.asp | resends a message | |
| | msgindetail.asp | | |
| attach.asp | update0.1.dll | gets one or more file attachments from either local hard disk or file server—the user can also | |
| | fileattfromserver.asp | delete any of the file attachments from the current list | |
| | msgnew.asp | | |
| | or msgfwd.asp | | |
| | or msgreply. asp | | |
| update01.dll | attach.asp | ISAPI that carries the actual file upload job—browser should support “file upload” tag | |
| | attach.asp | (Internet Explorer4 or Netscape3); one file is uploaded at a time | |
| fileattdetail.asp | fileatttoserver.asp | displays the details (name/date/size) of a file attachment—the user can download it or save it | |
| | msgin.asp | to the file server; the user can also convert the file to HTML format and view it online using | |
| | msgindetail.asp | a viewer | |
| fileatttoserver.asp | | saves file attachments to file server | |
| | fileattdetail.asp | | |
| fileattfromserver.asp | | gets file attachments from file server | |
| | attach.as | | |
| caleventnew.asp | | creates a new calendar event—a calendar event can be of one of the following types: normal, | |
| | menu2.asp | planning, production, follow-up, urgent, and adhoc; the user can share this event with | |
| | | friends, in which case an email reminder can be sent to specified recipients either immediately | |
| | | or a certain time before the start of the event (i.e., one day before the event start) | |
| caleventdetail.asp | | displays and edits an existing calendar event—only the specified friends are authorized to | |
| | calbymonth.asp | edit the calendar event | |
| | calbyday.asp | | |
| todonew.asp | | creates a new todo item—the user can share this todo with friends, in which case an email | |
| | menu2.asp | reminder can be sent to specified recipients either immediately or a certain time before the | |
| | | todo date (i.e., one day before the todo date) | |
| tododetail.asp | | displays and edits an existing todo item—only the specified friends are authorized to edit the | |
| | calbymonth.asp | todo item | |
| | calbyday. asp | | |
| calbymonth.asp | tododetail.asp | displays all calendar events and todo items in a monthly view | |
| | caleventdetail. asp | | |
| | calbyday.asp | | |
| | menu1.asp | | |
| | menu2.asp | | |
| calbyday.asp | tododetail.asp | displays all calendar events and todo items of one day | |
| | caleventdetail.asp | | |
| | calbymonth.asp | | |
| todolist.asp | tododetail.asp | displays all todo (not yet completed) items | |
| | menu1.asp | | |
| | menu2.asp | | |
| calsharenew.asp | | adds a new friend to share the user's calendar | |
| | calsharelist.asp | | |
| bookmarklist.asp | bookmarkdetail.asp | displays all bookmarks grouped by categories—the user can add, edit, or delete bookmarks; | |
| | msgnew.asp | the user can also convert bookmarks to email content and send it to others | |
| | menu1.asp | | |
| | menu2.asp | | |
| bookmarknew.asp | | adds a new bookmark | |
| | menu2.asp | | |
| bookmarkdetail.asp | | edits an existing bookmark | |
| | bookmarklist.asp | | |
| addbooklist.asp | addbooknew.asp | lists all address book entries—the address book is sorted by name and an A to Z index link is | |
| | addbookdetail.asp | available for fast first letter search; the user can add, edit, or delete address book entries; the | |
| | msgnew.asp | user can also select address book entries and use them as recipients for a new message by just | |
| | menu1.asp | one mouse click | |
| | menu2.asp | | |
| addbooknew.asp | | adds a new address book ently | |
| | menu2.asp | | |
| addbookdetail.asp | | edits an existing address book entry | |
| | addbooklist.asp | | |
| filebrowse.asp | filebrowse_friend.asp | file browser—there are four types of files: | |
| | filedetail.asp | (1) | Private: the user puts all private files in a private area; the user can either upload files to |
| | msgnew.asp | | this area from local hard disk or get files from the Friends/System area |
| | menu1.asp | (2) | Published: the user wants to let others to access the user's files; the user just puts those |
| | menu2.asp | | files to the Published area; the user can either upload files to this area from local hard |
| | | | disk or get files from the Friends/System area |
| | | (3) | Friends: get access to others' files by checking the Friends area; the user finds files |
| | | | “published” by others here in this area; the user can read the files but update is not |
| | | | allowed here |
| | | (4) | System: system administrator puts public files here; again, the user can read the files but |
| | | | update is not allowed here |
| | | | additional features: |
| | | (a) | unlimited number of nested folders are allowed |
| | | (b) | there is a file storage limit imposed on each user, depending on the package the user |
| | | | subscribed to |
| | | (c) | the user can convert files to file attachments in a new message |
| | | (d) | the user can convert files to HTML format and view it online using file viewer. |

| | | |
|---|---|---|
| filebrowse_friend.asp | | keeps a list of “friends” for fast access to their Published files—the user can add/delete |
| | filebrowse.asp | friends from the list; the user can search for users in the system by using wildcard |
| | | mechanism on usernames, and add them to the friend list |
| filedetail.asp | | displays the details (name/date/size) of a file—the user can download it or convert the file to |
| | filebrowse.asp | HTML fonnat and view it online using file viewer |
| menu1.asp | menu2.asp | displays authorized main functions on the left menu bar |
| menu2.asp | * | displays authorized sub-functions (of the selected main function) on the top menu bar |
| | menu1.asp | |
| popread.exe | | fetches POP3 e-mails to the system—POP3 e-mails can be either MAGICALLY.COM itself |
| | | or external; user may want to consolidate all e-mails in one place by fetching all of them in |
| | | the virtual desktop |

TABLE 2
Interactions Between Program Modules and Servers

| | | | | | Con- |
|---|---|---|---|---|---|
| | Data | E-Mail | Viewer | File | troller |
| Module Name | Server | Server | Converter | Server | Server |
| login.asp | Y | | | Y | Y |
| userreg.asp | Y | | | Y | Y |
| desktop.asp | Y | | | Y | |
| desktopwiz.asp | Y | | | Y | |
| msgnew.asp | Y | Y | | Y | |
| msgin.asp | Y | | | | |
| msgindetail.asp | Y | | | | |
| msgreply. asp | Y | | | | |
| msgfwd.asp | Y | | | | |
| msgresend.asp | Y | | | | |
| attach.asp | | | | Y | |
| update01.dll | | | | Y | |
| fileattdetail.asp | | | Y | Y | |
| fileatttoserver.asp | Y | | Y | | |
| fileattfromserver.asp | Y | | | Y | |
| caleventnew.asp | Y | Y | | | |
| caleventdetail.asp | Y | | | | |
| todonew.asp | Y | Y | | | |
| tododetail.asp | Y | | | | |
| calbymonth.asp | Y | | | | |
| calbyday.asp | Y | | | | |
| todolist.asp | Y | | | | |
| calsharelist.asp | Y | | | | |
| calsharenew.asp | Y | | | | |
| bookmarklist.asp | Y | | | | |
| bookmarknew.asp | Y | | | | |
| bookmarkdetail.asp | Y | | | | |
| addbooklist.asp | Y | | | | |
| addbooknew.asp | Y | | | | |
| addbookdetail.asp | Y | | | | |
| filebrowse.asp | Y | | | Y | |
| filebrowse_friend.asp | Y | | | | |
| filedetail.asp | | | | Y | |
| menu1.asp | Y | | | Y | |
| menu2.asp | Y | | | Y | |
| popread.exe | Y | Y | | | |

TABLE 3
Interactions Between Program Modules and Databases

| | | | | | | Calendar | | Bookmark | | | |
|---|---|---|---|---|---|---|---|---|---|---|---|
| | | | E-Mail Database | | | Database | | Database | | Address | |
| | User Info | Desktop | Mes- | | File | | | Book- | | Book | Friend |
| Module Name | Database | Database | sage | Recipient | Attachment | CalEvent | CalShare | -mark | Category | Database | Database |
| login.asp | R | | | | | | | | | | |
| userreg.asp | RW | RW | RW | RW | | | | | | | |
| desktop.asp | R | R | R | R | | R | | R | R | R | |
| desktopwiz.asp | R | RW | | | | | | | | | |
| msgnew.asp | R | | RW | RW | RW | | | | | R | |
| msgin.asp R | | R | R | R | | | | | | | |
| msgindetail.asp | R | | R | R | R | | | | | R | |
| msgreply.asp | R | | RW | RW RW | | | | | | | |
| msgfwd.asp | R | | RW | RW | RW | | | | | R | |
| msgresend.asp | R | | RW | RW | RW | | | | | | |
| attach.asp | | | | | | | | | | | |
| update01.dll | | | | | | | | | | | |
| fileattdetail.asp | | | | | R | | | | | | |
| fileatttoserver.asp | R | | R | R R | | | | | | | |
| fileattfromserver.asp | R | | R | R | R | | | | | | |
| caleventnew.asp | R | | RW | RW | | RW | R | | | | |
| caleventdctail.asp | R | | | | | RW | R | | | | |
| todonew.asp | R | | RW | RW | | RW | R | | | | |
| tododetail.asp | R | | | | | RW | R | | | | |
| calbymonth.asp | R | | | | | R | R | | | | |
| calbyday.asp | R | | | | | R | R | | | | |
| todolist.asp | R | | | | | R | | | | | |
| calsharelist.asp | | | | | | R | | | | | |
| calsharenew.asp | R | | | | | | RW | | | | |
| bookmarklist.asp | R | | | | | | | R | R | | |
| bookmarknew.asp | R | | | | | | | RW | R | | |
| bookmarkdetail.asp | R | | | | | | | RW | R | | |
| addbooklist.asp | R | | | | | | | | | R | |
| addbooknew.asp | R | | | | | | | | | RW | |
| addbookdetail.asp | R | | | | | | | | | RW | |
| filebrowse.asp | R | | | | | | | | | | |
| filebrowse_friend.asp | | | | | | | | | | RW | |
| filedetail.asp | | | | | | | | | | | |
| menu1.asp | R | | | | | | | | | | |
| menu2.asp | R | | | | | | | | | | |
| popread.exe | R | | RW | RW | RW | | | | | | |

What is claimed is:

1. A method for processing data in a computer desktop comprising:
receiving a message in the desktop;
displaying the received message;
receiving a selection of data included in the displayed message;
receiving a command to process the selected data in a particular manner;
extracting the selected data;
storing the extracted data in a database; and
generating and sending a reminder message in response to particular types of command.

2. The method of claim 1, wherein the selected data relates to a calendar event.

3. The method of claim 1, wherein the selected data relates to a to-do item.

4. The method of claim 1, wherein the reminder message is sent at one or more designated times.

5. The method of claim 1, wherein the reminder message is sent to one or more designated recipients.

6. The method of claim 1, wherein the message is displayed in a window, the window including a set of buttons for available commands.

7. A method for processing data in a computer desktop comprising:
receiving a message in the desktop;
displaying the received message;
receiving a selection of an item included in the displayed message,
wherein the selected item relates to a file, an address, a bookmark, a calendar event, or a to do item;
receiving a command to process the selected item in a particular manner;
extracting the selected item; and
storing the extracted item in a database.

8. The method of claim 7, further comprising:
receiving a selection for an item stored in the database; and
providing the selected item in a transmitted message.

9. A computer implemented method for processing data in a desktop comprising:
providing a messaging application that allows a user to send and receive messages, wherein the messaging application further allows the user to select and extract data included in a received message; and
providing a second application that receives the extracted data and, in response to particular types of received data, directs generation of a reminder message.

10. The method of claim 9, further comprising:
providing a third application that allows the user to manipulate files and folders, and
wherein the messaging application further allows the user to select and extract a file included in the received message, and wherein the third application saves the extracted file.

11. The method of claim 9, wherein the messaging application further allows the user to select and extract a URL link to a web site included in the message, the method further comprising:
providing a fourth application that receives the extracted URL link and saves the link in a bookmark database.

12. The method of claim 9, wherein the messaging application further allows the user to select and extract an address included in the received message, the method further comprising:
providing a fifth application that receives the extracted address and saves the address to an address database.

13. The method of claim 9, wherein the extracted data relates to a calendar event.

14. The method of claim 9, wherein the extracted data relates to a to-do item.

15. The method of claim 9, wherein the second application integrates the extracted data in an existing database.

16. The method of claim 9, wherein the received message is displayed in a window, the window including at least one button that facilitates extraction of the data included in the received message.

17. The method of claim 9, wherein the reminder message is sent at a time designated by the user.

18. The method of claim 9, wherein the reminder message is sent to one or more designated recipients.

19. A computer program product for processing data in a desktop comprising:
code that sends and receives messages;
code that displays a received message;
code that receives a selection of a data item in the displayed message;
code that receives a command to process the selected data in a particular manner;
code that extracts the selected data;
code that stores the extracted data in a database;
code that generates a reminder message in response to the extracted data;
code that sends the reminder message at one or more designated times; and
an electronics storage medium configured to store the codes.

20. The product of claim 19, wherein the received message is displayed on a window that includes at least one button provided to facilitate extraction of the selected data item.

21. The product of claim 19, further comprising:
code that receives a data item from the database; and
code that incorporates the data item from the database into a transmitted message.

22. A computer network configured to process data in a computing environment, the network comprising one or more servers, wherein at least one server comprises:
a processor;
an electronic storage medium; and
a memory,
wherein the at least one server is configured to
send and receive messages,
display a received message,
receive a data item included in the displayed message,
receive a command to process the selected data in a particular manner,
extract the selected data, and
store the data item in a database.

23. The network of claim 22, wherein the at least one server is further configured to
receive a data item from the database, and
incorporate the data item from the database into a transmitted message.

24. The network of claim 22, wherein the received message is displayed in a window, the window including at least one button that facilitates extraction of the data included in the received message

25. The network of claim 22, wherein the at least one server include a file server that stores the database for each user.
